(19) United States
(12) Patent Application Publication
(10) Pub. No.: US 2025/0066528 A1
(43) Pub. Date: Feb. 27, 2025

(54) Method for Synthesizing a Covalent Organic Framework Material

(71) Applicant: YOCOF MATERIAL (SUZHOU) CO., LTD., JIANGSU PROVINCE (CN)

(72) Inventors: Zhenjie ZHANG, JIANGSU PROVINCE (CN); Zhifang WANG, JIANGSU PROVINCE (CN); Zhengfeng ZHAO, JIANGSU PROVINCE (CN); Yao CHEN, JIANGSU PROVINCE (CN)

(21) Appl. No.: 18/723,994

(22) PCT Filed: Dec. 12, 2022
(86) PCT No.: PCT/CN2022/138498

§ 371 Date: Jun. 25, 2024

(30) Foreign Application Priority Data
Dec. 30, 2021 (CN) 202111650887.5

(51) Int. Cl. C08G 16/02; C08G 63/06

(52) U.S. Cl. CPC C08G 16/0268; C08G 63/065

(57) ABSTRACT

The present invention relates to a novel method for synthesizing olefin covalent organic framework foams, and polyimide, imine, hydrazone or Ketoenamine covalent organic frameworks (COFs). The method is a green synthetic strategy, including: under non-solvent condition, performing condensation reaction of a methyl-containing monomer and an aldehyde monomer with participation of acid anhydride or carboxylic acid compound to prepare olefin COFs; performing condensation reaction of a multihead acid anhydride or a multihead carboxylic acid monomer and an amino monomer with participation of acid anhydride or carboxylic acid compound to prepare amide COFs; and performing condensation reaction of the aldehyde monomer and the amino monomer with participation of acid anhydride, imidazole or carboxylic acid compound to prepare imine COFs. The COFs obtained by using the method have large specific surface area, regular and adjustable porous structure, and high crystallinity. The method effectively avoids use of organic solvent and risk of high pressure in the reaction process, and is suitable for large-scale preparation of COF materials.

### RELATED APPLICATIONS

This is a U.S. national phase application of PCT/CN2022/138498 filed Dec. 12, 2022, which claims the benefit of CN202111650887.5 filed Dec. 30, 2021, each of which is incorporated herein by reference in its entirety.

### FIELD OF THE INVENTION

The present invention belongs to the field of porous organic materials, and particularly to method for making a covalent organic framework material with green solid-phase synthesis.

### BACKGROUND OF THE INVENTION

Covalent organic framework (hereinafter COF) materials are two-dimensional (2D) or three-dimensional (3D) porous crystalline organic polymeric materials linked by organic monomers through covalent bonds, and have the advantages of low density, large specific surface area, stable structural rule, uniform pore diameter, easy functionalization, etc. Through rational functional design of COF materials, COFs are widely used in the fields of gas adsorption separation, catalysis, drug delivery, supercapacitors, etc. In order to meet the growing needs, the types of COFs are also enriched continuously. Currently, the reported types of COFs include boronate ester linkage, imine linkage, hydrazone linkage, Ketoenamine linkage, polyimide linkage, olefin linkage, etc. Its synthesis method mainly utilizes solvothermal preparation, requires special organic solvents and catalysts as reaction media, which is both time-consuming and environmentally unfriendly. And this type of solvothermal reaction is performed in a closed glass tube or a closed vessel, and its high-temperature and high-pressure reaction conditions severely hinder large-scale production of the COFs.

With the government's requirements for low energy consumption and low pollution, as well as the increasing awareness of environmental protection among people, the development of green and environmentally friendly preparation methods for synthesizing a large number of COFs to further meet the practical application of COF materials has become an urgent problem to be solved in the field of COF materials. Recently, environmental-friendly methods such as ionic liquid synthesis, microwave-assisted synthesis and mechanical-chemical synthesis have been used in synthesis of the COFs. However, these methods are confined and can only realize synthesis of individual COFs, without wide universality. Therefore, it is urgent to develop a simple, highly universal, green, pollution-free and suitable synthesis method for large-scale production to prepare COF materials configured with one of olefin linkage, imide linkage, boronate ester linkage, boroxine linkage, imine linkage, azine linkage, Ketoenamine linkage, hydrazone linkage and triazine linkage, which has practical significance.

On the one hand, by regulating and screening organic monomers and synthetic conditions of the COFs, using suitable catalyst, such that a green synthesis method with non-solvent participation is developed to prepare high-crystallinity COF materials. On the other hand, compared with conventional solvothermal synthesis, non-solvent participation can effectively avoid high pressure operating condition, so that the method is suitable for large-scale production of the COFs. In addition, selecting functionalized organic monomers as building units can prepare COF materials with special functions.

### OBJECTS AND SUMMARY OF THE INVENTION

An object of the present invention is to provide a novel, green and solvent-free synthesis method for COFs configured with one of olefin linkage, imide linkage, boronate ester linkage, boroxine linkage, imine linkage, azine linkage, Ketoenamine linkage, hydrazone linkage and triazine linkage.

Another object of the present invention is to provide cheaper reaction monomers for synthesizing COFs configured with one of olefin linkage, imide linkage, boronate ester linkage, boroxine linkage, imine linkage, azine linkage, Ketoenamine linkage, hydrazone linkage and triazine linkage to realize massive preparation of COFs and to prepare novel COFs.

The object of the present invention is also to provide a novel method for synthesizing COF foam configured with one of olefin linkage, imide linkage, boronate ester linkage, boroxine linkage, imine linkage, azine linkage, Ketoenamine linkage, hydrazone linkage and triazine linkage to synthesize a series of novel COFs, and to illustrate advantages of the foam material in adsorption separation.

For those skilled in the art, other objects of the present invention may be clear directly from descriptions above and below.

The first aspect of the present invention is to provide method for making covalent organic framework materials with solid-phase synthesis, characterized in that the covalent organic framework materials are configured with one of olefin linkage, imide linkage, boronate ester linkage, boroxine linkage, imine linkage, azine linkage, Ketoenamine linkage, hydrazone linkage and triazine linkage, which are specifically synthesized by the following steps:

The first organic monomer and second organic monomer are prepared in a condensation reaction under a solvent-free condition aided by a catalyst.

Preferably, the synthesis method is an in-situ growth method, specifically including: grinding the catalyst, the first organic monomer and the second organic monomer into slurry or grinding the same uniformly, coating on any substrate or directly placing in a closed reaction vessel, and performing high temperature polymerization to obtain the covalent organic framework materials.

Preferably, the reaction is performed under non-solvent condition, including the following steps:
adding the catalyst to the first organic monomer and the second organic monomer under the solvent-free condition to obtain a first product;
purifying the first product to obtain a second product; and
subjecting the second product to supercritical carbon dioxide or heating the second product in a vacuum to obtain the covalent organic framework material.

Preferably, the first organic monomer includes one of 2-connector building blocks which include a carboxylic acid anhydride functional group, 2-connector building blocks which include a carboxylic acid functional group, 2-connector building blocks which include an aldehyde group functional group or 3-connector building blocks which include an aldehyde group functional group.

Further preferably, the first organic monomer includes one of: phenylboronic acid; benzaldehyde; 2,4,6-trihydroxy benzene-1,3,5-trioxin; phthalic anhydride; hydroxyl propanone; phenyldione and a dicarboxylic acid anhydride. More preferably, the first organic monomer includes one of 2-connector or 3-connector building blocks which include a benzaldehyde, 2-connector building blocks which include a benzoic anhydride, 2-connector building blocks which include a phthalic acid. When the first organic monomer includes a 2-connector building block, the 2-connector building block includes linear molecules. When the first organic monomer includes a 3-connector building block, the 3-connector building block includes a 120° angle.

Preferably, the second organic monomer includes one of 2-connector building blocks which include an amino functional group, 3-connector building blocks which include an amino functional group, 4-connector building blocks which include an amino functional group, 2-connector building blocks which include an active methyl functional group or 3-connector building blocks which include an active methyl functional group.

Further preferably, the second organic monomer includes one of: pyrocatechol; phenylamine; benzoyl hydrazine; hydrazine hydrate; cyanobenzene; phenylacetonitrile; dimethylpyrazine; benzamidine; o-phenylenediamin; and triamine; further preferably, the second organic monomer includes one of: 2-connector, 3-connector or 4-connector building blocks which include phenylamine, 2-connector or 3-connector building blocks which include benzoyl hydrazine, hydrazine hydrate, 2-connector or 3-connector building blocks which include active methyl. When the second organic monomer includes a 2-connector building block, the 2-connector building block includes linear molecules. When the second organic monomer includes a 3-connector building block, the 3-connector building block includes a 120° angle. When the second organic monomer includes a 4-connector building block, the 4-connector building block includes a 120° angle.

Preferably, the catalyst includes one of an acid anhydride functional group, a carboxylic acid functional group, an imidazole functional group and a hydroxyl functional group.

Further preferably, the catalyst includes, with or without substitution, one of benzoic anhydride, 4-trifluoromethyl benzoic anhydride, phenylacetic anhydride, acetic anhydride, trifluoroacetic anhydride, benzoic acid, 4-fluorobenzoic acid, 4-bromobenzoic acid, propanoic acid, aromatic acid, imidazole, benzimidazole and phenol.

In a preferred solution of the present invention, the first organic monomer includes one of: terephthalaldehyde; 1,4-bis(4-aldehyde phenyl)benzene; 4,4′-biphenyl formaldehyde; 1,2-bis(4′-aldehyde phenyl)acetylene; 4,4′-(1,3-butadiyne-1,4-diyl)dibenzaldehyde; 2,5-bimethoxyl-1,4-terephthalaldehyde; 4,7-bis(4-aldehyde phenyl)benzofuran; 4,7-bis(4-aldehyde phenyl)benzothiophene; 4,7-bis(4-aldehyde phenyl)benzoselenophene; 1,3,5-benzenetricarboxaldehyde; 2-hydroxyl-1,3,5-benzenetrialdehyde; 2,4-dihydroxyl-1,3,5-benzenetricarboxaldehyde; 2,4,6-trihydroxyl-1,3,5-benzenetricarboxaldehyde; 1,3,5-tris(4′-aldehyde [1,1′-biphenyl]-4-yl)benzene; 1,3,5-tris(p-aldehyde phenyl)benzene; 4,4,4′-[benzene-1,3,5-triyl tris(acetylene-2,1-diyl)]tribenzaldehyde; 2,4,6-tris(4-aldehyde phenyl)-1,3,5-triazine; 4,4″,4′-(1,3,5-triazine-2,4,6-triyl) tris(([1,1-biphenyl]-4-formaldehyde)); and 2,4,6-tris(4-aldehyde-biphenyl-4-yl)-1,3,5-triazine.

The second organic monomer includes one of: 2,5-dimethylpyrazine; tetramethylpyrazine; 3,6-dimethylpyridazine; 2,5-dimethylterephthalonitrile; 2,4,6-trimethyl-1,3,5-triazine; 2,4,6-trimethylpyridine; 2,4,6-trimethyl-pyrimidine; 2,4,6-trimethyl-pyrimidine-5-formonitrile; 2,4,6-trimethylpyridine-3,5-diformonitrile; 2,4,6-tricyano-1,3,5-trimethylbenzene; and 2,2′-dipyridyl-5,5′-diacetonitrile.

Wherein, the 2-connector second organic monomer reacts in combination with the 3-connector first organic monomer, or the 2-connector first organic monomer reacts in combination with the 3-connector second organic monomer.

In a preferred solution of the present invention, the first organic monomer includes one of: pyromellitic dianhydride (PMDA); naphthalene-1,4,5,8-tetracarboxylic acid dianhydride (NTCDA); pyromellitic acid (PA); naphthalene-1,4,5,8-tetracarboxylic acid (NTA); terephthalaldehyde; 1,4-bis(4-aldehyde phenyl)benzene; 4,4′-biphenyl formaldehyde; 1,2-bis(4′-aldehyde phenyl)acetylene; 4,4′-(1,3-butadiyne-1,4-diyl)dibenzaldehyde; 2,5-bimethoxyl-1,4-terephthalaldehyde; 1,3,5-benzenetricarboxaldehyde; 2-hydroxyl-1,3,5-benzenetrialdehyde; 2,4-dihydroxyl-1,3,5-benzenetricarboxaldehyde; 2,4,6-trihydroxyl-1,3,5-benzenetricarboxaldehyde; 1,3,5-tris(4′-aldehyde [1,1′-biphenyl]-4-yl)benzene; 1,3,5-tris(p-aldehyde phenyl)benzene; 4,4,4′-[benzene-1,3,5-triyl tris(acetylene-2,1-diyl)]tribenzaldehyde; 2,4,6-tris(4-aldehyde phenyl)-1,3,5-triazine; 4,4″,4″-(1,3,5-triazine-2,4,6-triyl) tris(([1,1-biphenyl]-4-formaldehyde)); and 2,4,6-tris(4-aldehyde-biphenyl-4-yl)-1,3,5-triazine.

The second organic monomer includes one of: p-phenylenediamine; 2,5-diaminopyridine; benzidine; 4,4′-diaminoterphenyl; hydrazine hydrate; terephthalic dihydrazide; 2,5-diethoxybenzene-1,4-bis(aldehyde hydrazine); 2,5-bis(allyloxy)p-phenylhydrazide; 1,3,5-tris(4-aminophenyl)benzene (TAPB); 2,4,6-tris(4-aminophenyl)-1,3,5-triazine (TAPT); tris(4-aminophenyl amine) (TAPA); 5″-(4′-amino [1,1′-biphenyl]-4-yl)[1,1′:4′,1″:3″,1′″:4″″,1″″-quinquephenyl]-4,4″-diamine (TABPB); 4′,4′″,4″″-(1,3,5-triazine-2,4,6-triyl)tris(([[1,1′-biphenyl]-4-amine)) (TTBT); 2,7,12-triamino-5H-diindolyl[1,2-a:1′,2′-c]fluorene-5,10,15-trione (TRO); 2,4,6-tris(3-hydroxyl-4-amino phenyl)-1,3,5-triazine; benzene-1,3,5-tricarbohydrazide; N,N,N′,N′-tetra(p-amino phenyl)p-phenylenediamine; and tetra-(4-amino phenyl)vinyl.

Wherein, the 2-connector second organic monomer reacts in combination with the 3-connector first organic monomer, or the 2-connector first organic monomer reacts in combination with the 3-connector or 4-connector second organic monomer.

Preferably, covalent organic framework materials (COFs) are polyimide type covalent organic frameworks, olefin linked covalent organic frameworks foams, imine linked covalent organic frameworks, azine linked covalent organic frameworks, hydrazone linked covalent organic frameworks and Ketoenamine covalent organic framework materials.

Preferably, the covalent organic framework material forms one of blocks, cylinders and foams.

Preferably, the covalent organic framework material has pores whose diameter ranges from 0.6-4.9 nm, more preferably 1.8-4.9 nm.

Preferably, in the reaction system, a molar ratio of the first organic monomer to the second organic monomer is 1:4 to 4:1, more preferably 1:1 to 1:2.

Preferably, in the reaction system, a molar ratio of the catalyst to the first organic monomer is 1:5 to 5:1, more preferably 1:3 to 3:1.

Preferably, the pressure of the reaction system is 0-1 atm.

Preferably, the synthesis temperature is 20-200° C., more preferably 150-250° C., particularly preferably 180-200° C.

Preferably, the reaction time is 3-7 days, more preferably 5 days.

Preferably, the closed reaction vessel is one of a Pyrex tube that is resistant to high temperature and high pressure, an ampoule bottle that requires flame sealing, and a steel high-pressure reaction vessel lined with polytetrafluoroethylene.

Preferably, the building blocks and a low-melting point organic compound are placed in a closed vessel with a certain equivalence ratio, the pressure inside the vessel is vacuumed to 0.15 mmHg for half an hour. The sealed reaction vessel is placed in a 200° C. oven for 3-5 days through flame sealing tube. After the reaction is completed, the obtained solid powder is washed with DMF to remove unreacted monomers, and then washed with CH₃OH to remove excess added regulators. Subsequently, the obtained solid powder is extracted by Soxhlet extraction in anhydrous tetrahydrofuran solvent for 12 hours to remove unreacted small molecules in the pores. Finally, the obtained solid powder is heated and dried in a vacuum high-temperature oven under the temperature of 100° C. condition for 12 hours to obtain high-crystallinity covalent organic framework material.

Preferably, the reaction system does not require the addition of organic solvents and belongs to solid-state reaction system.

On the other hand, the present invention provides a simple and green synthesis method for COF materials, firstly selecting low-melting point benzoic anhydride and benzoic acid as catalysts, reacting 2,5-dimethylpyrazine monomer or 2,4,6-trimethyl-1,3,5-triazine and 3-connector aldehyde (including: 1,3,5-tris(4′-aldehyde [1,1′-biphenyl]-4-yl)benzene; 1,3,5-tris(p-aldehyde phenyl)benzene; 4,4,4′-[benzene-1,3,5-triyl tris(acetylene-2,1-diyl)]tribenzaldehyde; 2,4,6-tris(4-aldehyde phenyl)-1,3,5-triazine; 4,4″,4′″-(1,3,5-triazine-2,4,6-triyl) tris(([1,1-biphenyl]-4-formaldehyde)); 2,4,6-tris(4-aldehyde-biphenyl-4-yl)-1,3,5-triazine; and 1,3,5-benzenetricarboxaldehyde) or 2-connector aldehyde (including: terephthalaldehyde; 1,4-bis(4-aldehyde phenyl)benzene; 4,4′-biphenyl formaldehyde; 1,2-bis(4′-aldehyde phenyl)acetylene; 4,4′-(1,3-butadiyne-1,4-diyl)dibenzaldehyde; 2,5-bimethoxyl-1,4-terephthalaldehyde; 4,7-bis(4-aldehyde phenyl)benzofuran; 4,7-bis(4-aldehyde phenyl)benzothiophene; 4,7-bis(4-aldehyde phenyl)benzoselenophene) under solvent-free conditions to obtain products. Due to the lower melting point (43° C.) of benzoic anhydride, which is conducive to the shaping of COFs, olefin COF foam material can be prepared by combining the low-melting point characteristic of 2,5-dimethylpyrazine or 2,4,6-trimethyl-1,3,5-triazine monomer and reacting with trialdehyde monomer at high temperature.

A green solvent-free synthesis method is suitable for the preparation of polyimide type covalent organic frameworks, olefin linked covalent organic framework foams, imine linked covalent organic frameworks, azine linked covalent organic frameworks, hydrazone linked covalent organic frameworks and Ketoenamine covalent organic framework materials. In a high-vacuum degree closed reaction vessel, two building units are dehydrated and condensed at high temperature with the assistance of another low-melting point compound to prepare covalent organic framework materials with uniform pore size, high crystallinity and high specific surface area.

Another aspect of the present invention is the synthesis of polyimide COFs of general formula 1.

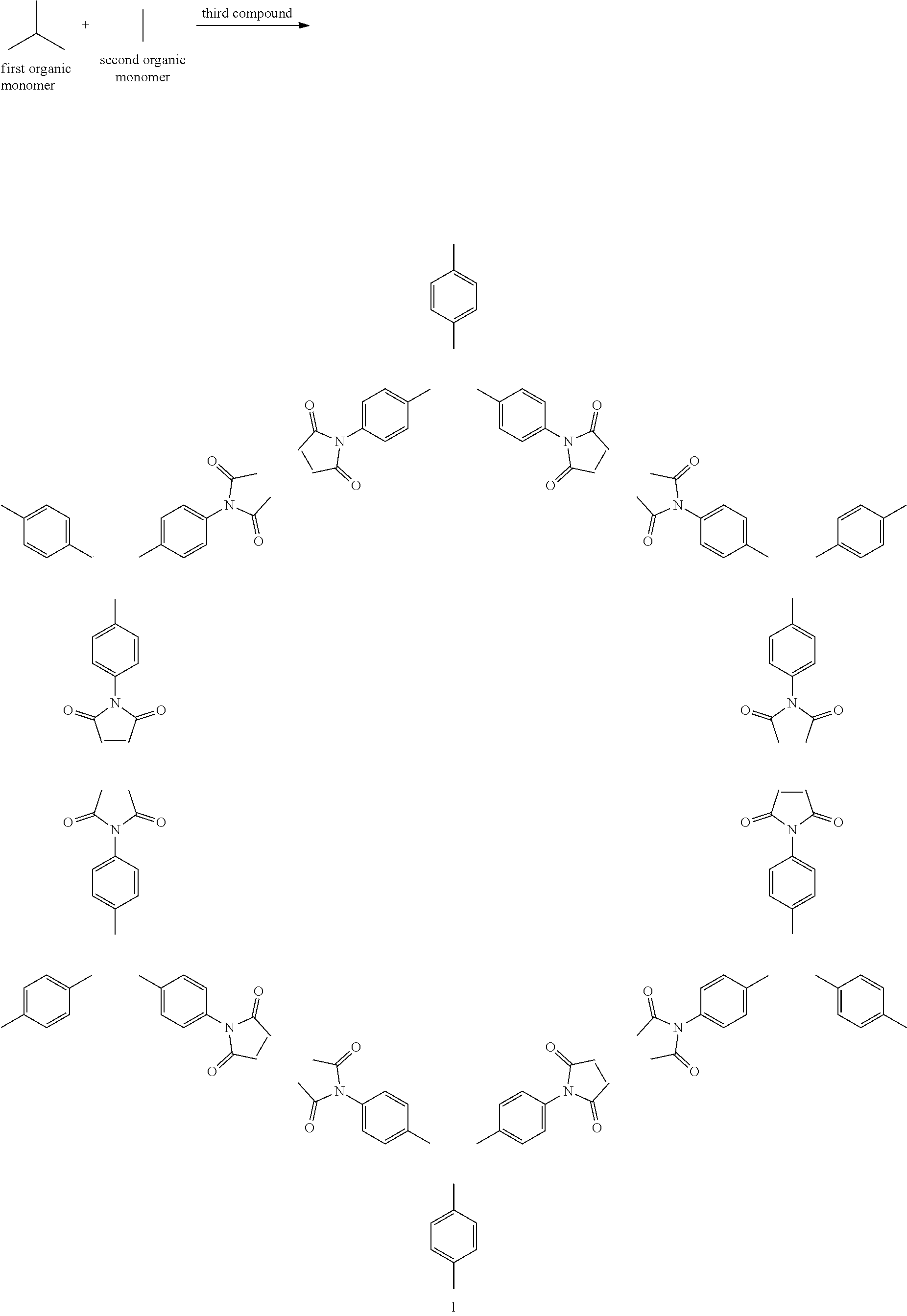

Wherein, the first organic monomer mainly includes 2-connector building blocks which include acid anhydride functional group such as pyromellitic dianhydride (PMDA); and naphthalene-1,4,5,8-tetracarboxylic acid dianhydride (NTCDA); or 4-connector building blocks which include carboxylic acid functional group such as pyromellitic acid (PA); and naphthalene-1,4,5,8-tetracarboxylic acid (NTA).

The second organic monomer mainly includes 3-connector building blocks which include amino functional group such as 1,3,5-tris(4-aminophenyl)benzene (TAPB); 2,4,6-tris(4-aminophenyl)-1,3,5-triazine (TAFT); tris(4-aminophenyl amine) (TAPA); 5″-(4′-amino[1,1′-biphenyl]-4-yl)[1,1′:4′,1″:3″,1′″:4′″,1″″-quinquephenyl]-4,4′″-diamine (TABPB); 4′,4′″,4′″″-(1,3,5-triazine-2,4,6-triyl)tris(([[1,1′-biphenyl]-4-amine)) (TTBT); 2,7,12-triamino-5H-diindolyl[1,2-a:1′,2′-c]fluorene-5,10,15-trione (TRO); 2,4,6-tris(3-hydroxyl-4-amino phenyl)-1,3,5-triazine; N,N,N′,N′-tetra(p-amino phenyl)p-phenylenediamine; and tetra-(4-amino phenyl)vinyl.

The third compound mainly includes compound containing acid anhydride functional group such as benzoic anhydride (BZDA), 4-trifluoromethylbenzoic anhydride (TFBA) and acetic anhydride (AA); or compound containing carboxylic acid functional group such as benzoic acid (BA), 4-fluorobenzoic acid (FBA) and propanoic acid (PA).

The first organic monomer and second organic monomer as mentioned above can be freely combined, and target COFs can also be prepared under any one of the participating conditions in third compound.

Another aspect of the present invention is the synthesis of olefin COFs of general formula 2.

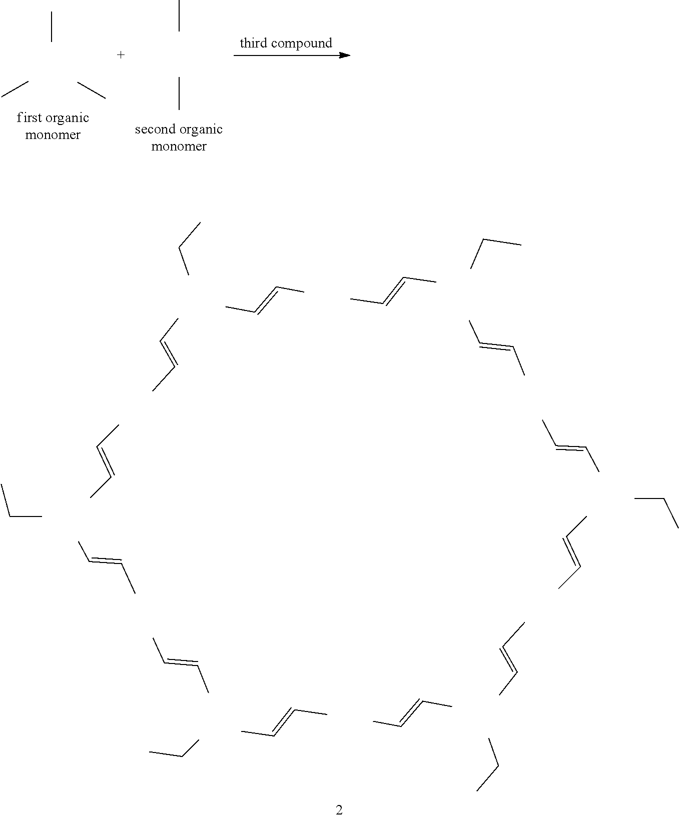

The first organic monomer mainly includes: 1,3,5-tris(4′-aldehyde [1,1′-biphenyl]-4-yl)benzene; 1,3,5-tris(p-aldehyde phenyl)benzene; 4,4,4′-[benzene-1,3,5-triyl tris(acetylene-2,1-diyl)]tribenzaldehyde; 2,4,6-tris(4-aldehyde phenyl)-1,3,5-triazine; 4,4″,4′″-(1,3,5-triazine-2,4,6-triyl) tris(([1,1-biphenyl]-4-formaldehyde)); 2,4,6-tris(4-aldehyde-biphenyl-4-yl)-1,3,5-triazine; 1,3,5-benzenetricarboxaldehyde; terephthalaldehyde; 1,4-bis(4-aldehyde phenyl)benzene; 4,4′-biphenyl formaldehyde; 1,2-bis(4′-aldehyde phenyl)acetylene; 4,4′-(1,3-butadiyne-1,4-diyl)dibenzaldehyde; 2,5-bimethoxyl-1,4-terephthalaldehyde; 4,7-bis(4-aldehyde phenyl)benzofuran; 4,7-bis(4-aldehyde phenyl)benzothiophene; and 4,7-bis(4-aldehyde phenyl)benzoselenophene.

The second organic monomer mainly includes: 2,4,6-trimethyl-1,3,5-triazine; 2,4,6-trimethylpyridine-3,5-diformonitrile; 2,4,6-tricyano-1,3,5-trimethylbenzene; 2,5-dimethylpyrazine; 3,6-dimethylpyridazine; and 2,5-dimethylterephthalonitrile.

The first organic monomer and second organic monomer as mentioned above can be freely combined, and target COFs can also be prepared under any one of the participating conditions in third compound.

Another aspect of the present invention is the synthesis of hydrazone bond COFs of general formula 3.

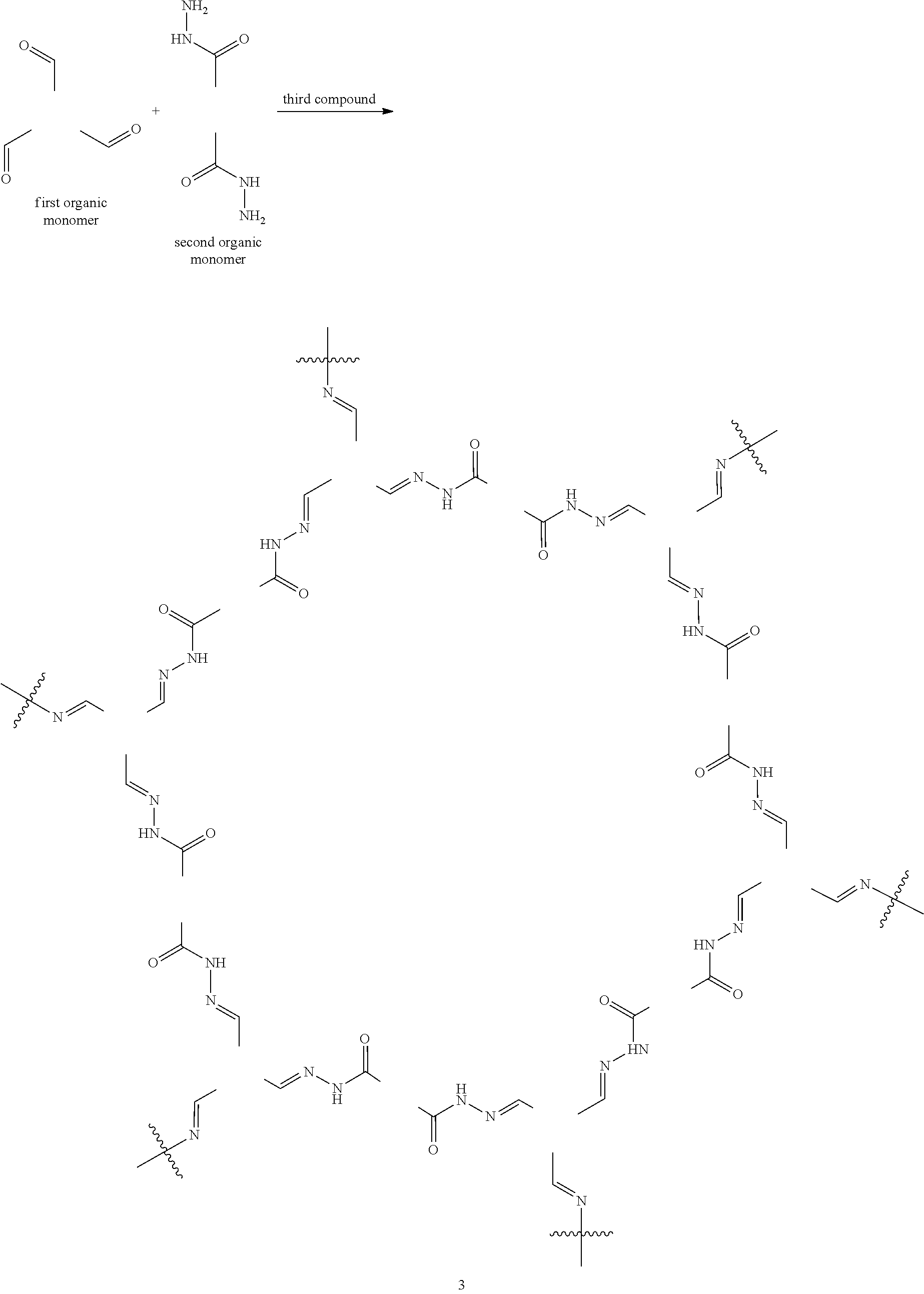

The first organic monomer mainly includes: 1,3,5-tris(4′-aldehyde [1,1′-biphenyl]-4-yl)benzene; 1,3,5-tris(p-aldehyde phenyl)benzene; 4,4,4′-[benzene-1,3,5-triyl tris(acetylene-2,1-diyl)]tribenzaldehyde; 2,4,6-tris(4-aldehyde phenyl)-1,3,5-triazine; 4,4″,4′″-(1,3,5-triazine-2,4,6-triyl) tris(([1,1-biphenyl]-4-formaldehyde)); 2,4,6-tris(4-aldehyde-biphenyl-4-yl)-1,3,5-triazine; and 1,3,5-benzenetricarboxaldehyde.

The second organic monomer mainly includes: terephthalic dihydrazide; 2,5-diethoxybenzene-1,4-bis(aldehyde hydrazine); 2,5-bis(allyloxy)p-phenylhydrazide; and benzene-1,3,5-tricarbohydrazide.

The third compound mainly includes: benzoic anhydride, benzimidazole and benzoic acid.

The first organic monomer and second organic monomer as mentioned above can be freely combined, and target COFs can also be prepared under any one of the participating conditions in third compound.

Another aspect of the present invention is the synthesis of imine COFs of general formula 4.

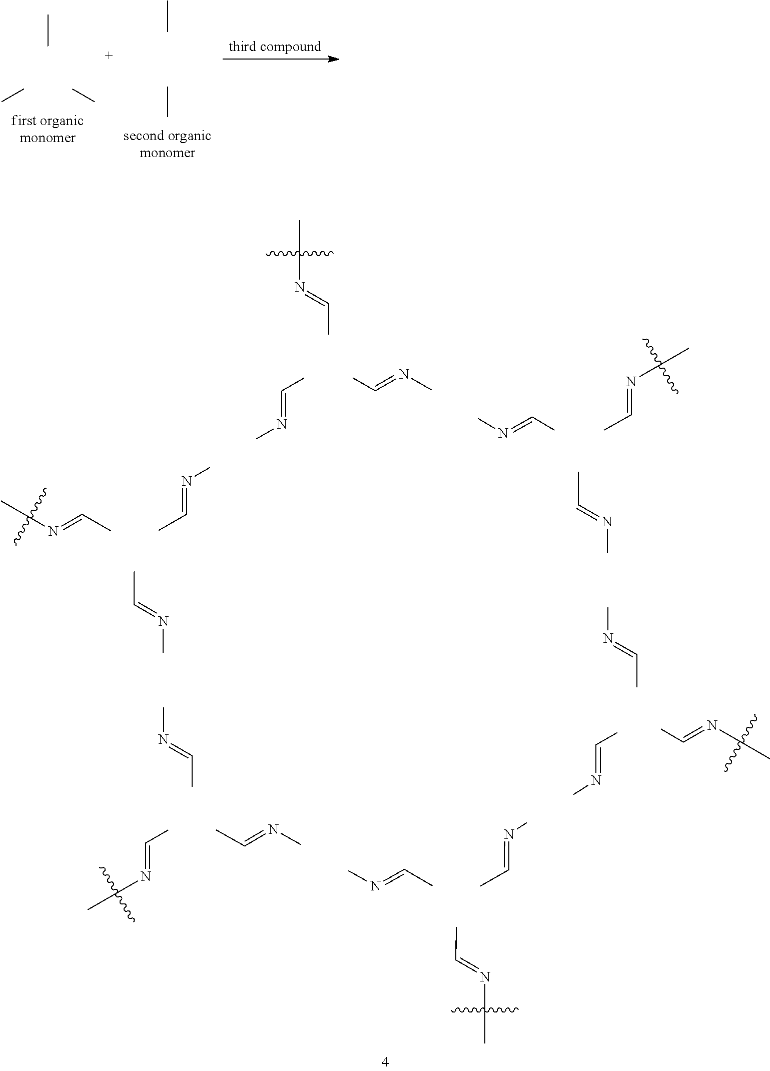

The first organic monomer mainly includes: 1,3,5-tris(p-aldehyde phenyl)benzene; 2,4,6-tris(4-aldehyde phenyl)-1,3,5-triazine; 1,3,5-benzenetricarboxaldehyde; 2-hydroxyl-1,3,5-benzenetrialdehyde; 2,4-dihydroxyl-1,3,5-benzenetricarboxaldehyde; terephthalaldehyde; 4,4′-biphenyl formaldehyde1,4-bis(4-aldehyde phenyl)benzene; and 1,2-bis(4′-aldehyde phenyl)acetylene.

The second organic monomer mainly includes: 1,3,5-tris(4-aminophenyl)benzene; 2,4,6-tris(4-aminophenyl)-1,3,5-triazine; tris(4-aminophenyl)amine; p-phenylenediamine; 2,5-diaminopyridine, benzidine; 4,4′-diaminoterphenyl; and hydrazine hydrate.

The third compound mainly includes: benzoic anhydride, benzimidazole and benzoic acid.

The first organic monomer and second organic monomer as mentioned above can be freely combined, and target COFs can also be prepared under any one of the participating conditions in third compound, wherein the second organic monomer is hydrazine hydrate, and the prepared COFs are azine linked covalent organic framework materials.

Another aspect of the present invention is the synthesis of Ketoenamine COFs of general formula 5.

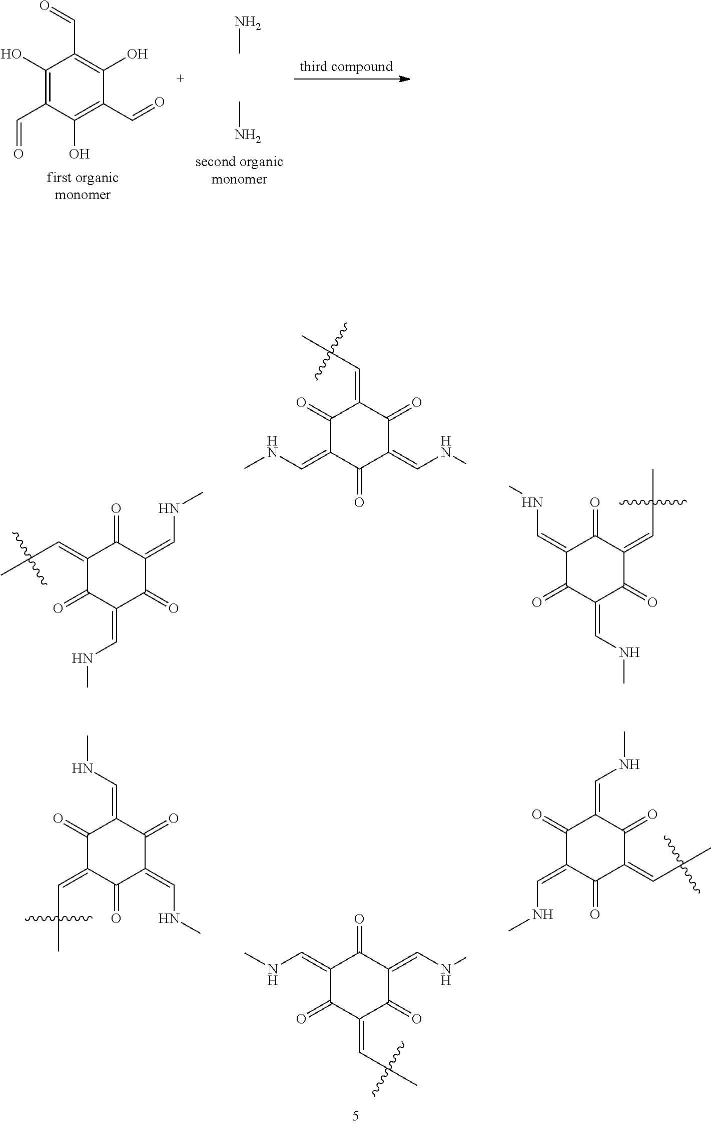

The first organic monomer is 2,4,6-trihydroxybenzene-1,3,5-tricarbaldehyde.

The second organic monomer mainly includes: p-phenylenediamine; 2,5-diaminopyridine; benzidine; 4,4′-diaminoterphenyl; hydrazine hydrate; 1,3,5-tris(4-aminophenyl)benzene; 2,4,6-tris(4-aminophenyl)-1,3,5-triazine; and tris(4-aminophenyl)amine.

The first organic monomer and second organic monomer as mentioned above can be freely combined, and target COFs can also be prepared under any one of the participating conditions in third compound.

Compared with the prior art, this invention has the following innovations:

1. The existing synthesis methods of covalent organic framework materials configured with one of olefin linkage, imide linkage, boronate ester linkage, boroxine linkage, imine linkage, azine linkage, Ketoenamine linkage, hydrazone linkage and triazine linkage have been optimized, expanding the number of reaction monomers, reducing material costs, avoiding the use of highly toxic catalysts and solvents through solvent-free synthesis, reducing energy consumption, improving crystallinity and specific surface area of covalent organic frameworks, and having excellent universality.

2. The existing synthesis methods of covalent organic framework materials configured with one of olefin linkage, imide linkage, boronate ester linkage, boroxine linkage, imine linkage, azine linkage, Ketoenamine linkage, hydrazone linkage and triazine linkage have been optimized, avoiding the use of highly toxic catalysts and solvents through solvent-free synthesis, reducing the time for screening reaction conditions. Thanks to the advantages of easy molding by solid phase reaction, high-crystallinity covalent organic framework foam can be prepared in one step.

3. The solid catalysts selected in this invention, such as the following substituted or unsubstituted compounds such as benzoic anhydride, 4-trifluoromethylbenzoic anhydride, phenylacetic anhydride, acetic anhydride, trifluoroacetic anhydride, benzoic acid, 4-fluorobenzoic acid, 4-bromobenzoic acid, propanoic acid, aromatic acid, imidazole, benzimidazole or phenol, etc., are the first attempts in this research field, successfully avoiding the participation of organic solvents, effectively reducing the risk of the reaction, providing a new method for the large-scale production of covalent organic framework materials.

### BRIEF DESCRIPTION OF FIGURES

FIGS. 1A-1B illustrate the structural formulas of some organic monomers used in the synthesis of covalent organic framework materials used in the present invention. FIG. 1A is first organic monomer. FIG. 1B is second organic monomer;

FIGS. 2A-2D illustrate the schematic synthesis routes of some covalent organic framework materials prepared by the present invention. FIG. 2A shows the polyimide covalent organic framework. FIG. 2B shows the olefin covalent organic framework. FIG. 2C shows the imine or hydrazone bond covalent organic framework. FIG. 2D shows the Ketoenamine covalent organic framework;

FIGS. 3A-3E illustrate powder diffraction patterns of several representative covalent organic framework materials prepared by the present invention;

FIGS. 4A-4E illustrate infrared spectra of several representative covalent organic framework materials prepared by the present invention; and

FIGS. 5A-5E illustrate 77K nitrogen isothermal adsorption-desorption curves of several representative covalent organic framework materials prepared by the present invention.

Note: due to the large variety and quantity of covalent organic framework materials prepared, only one material characterization data graph is provided for each covalent organic framework.

### DETAILED DESCRIPTION OF THE EMBODIMENTS

The following will provide further detailed descriptions of the present invention in conjunction with the embodiments and accompanying drawings, so that those skilled in the art can refer to the text of the specification and implement it accordingly. Unless otherwise stated in the context of this application, technical terms and abbreviations used in this application have common meanings known to those skilled in the art; unless otherwise specified, the raw material compounds used in the following embodiments are commercially available.

According to the invention, the preparation of polyimide type covalent organic framework, olefin linked covalent organic framework foam, imine linked covalent organic framework, hydrazone linked covalent organic framework and Ketoenamine covalent organic framework materials, the synthesis of six kinds of polyimide type covalent organic framework materials and the related performance characterization test, the specific implementation methods are as follows. On the contrary, the following embodiments are only intended to further explain the present invention and should not be considered as limiting the scope of the present invention.

Embodiments 1-14 are preparation methods of polyimide type covalent organic framework materials. Embodiments 15-17 are preparation methods of olefin covalent organic framework foams. Embodiments 18 and 19 are preparation methods of hydrazone bond covalent organic framework material. Embodiments 20 and 21 are preparation methods of imine type covalent organic framework materials. Embodiments 22 and 23 are preparation methods of Ketoenamine covalent organic framework materials, wherein each material can obtain high-crystallinity covalent organic framework materials by replacing six different acid anhydride or aromatic acid regulators.

### Example 1

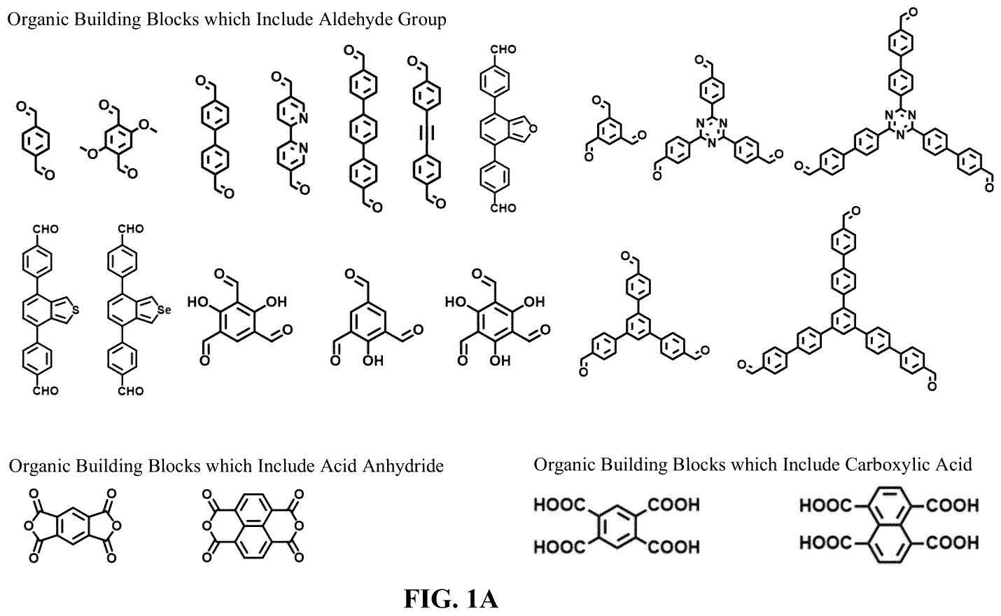

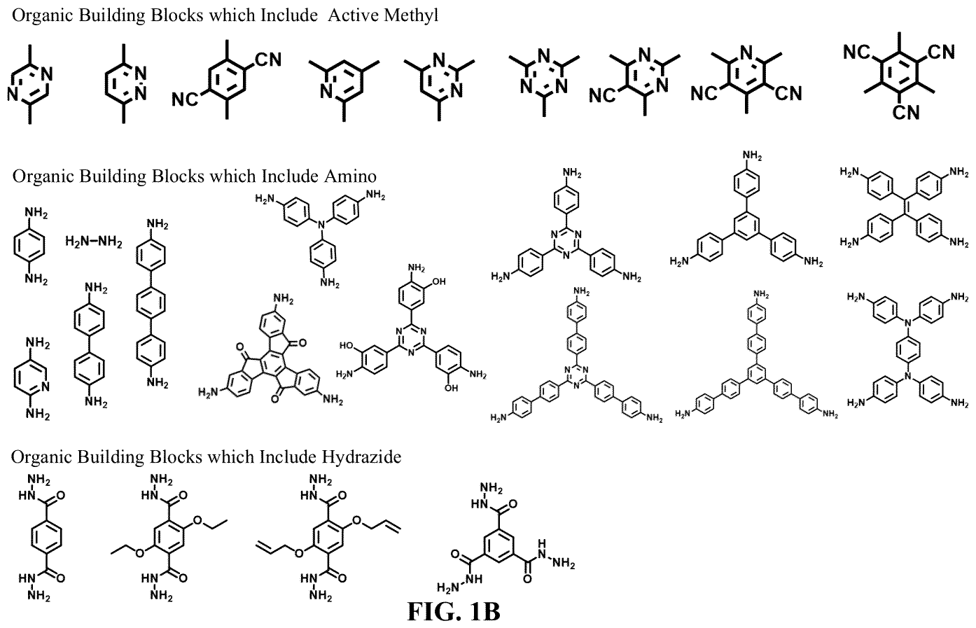

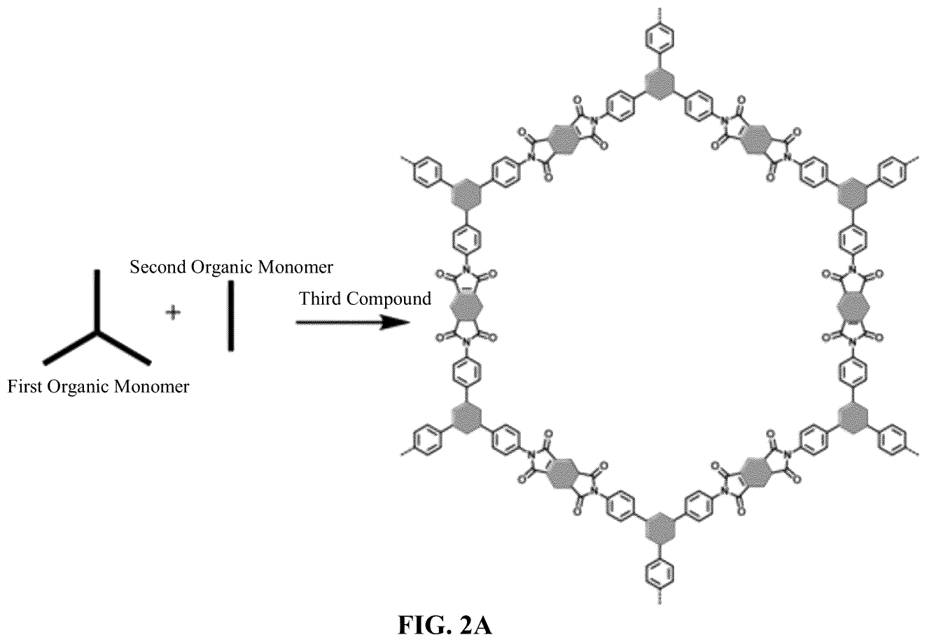

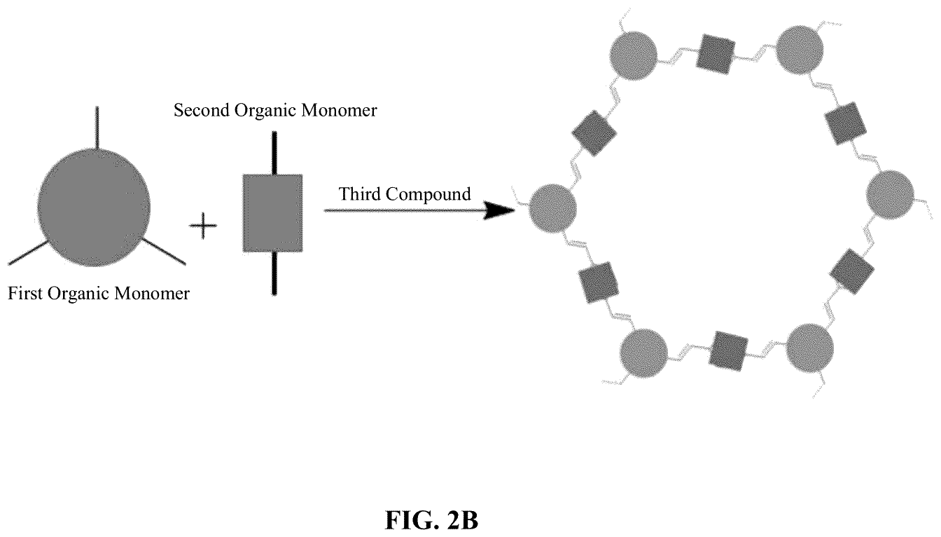

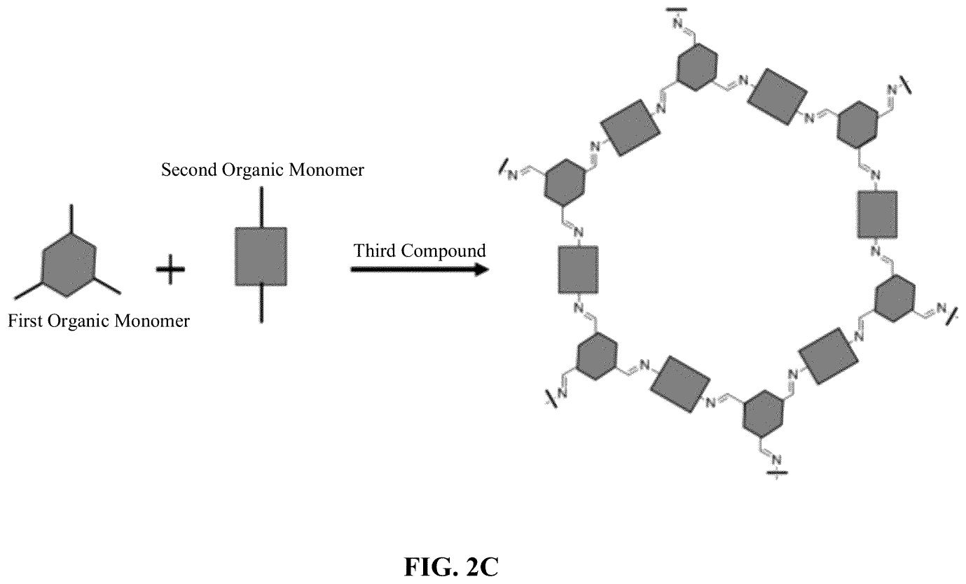

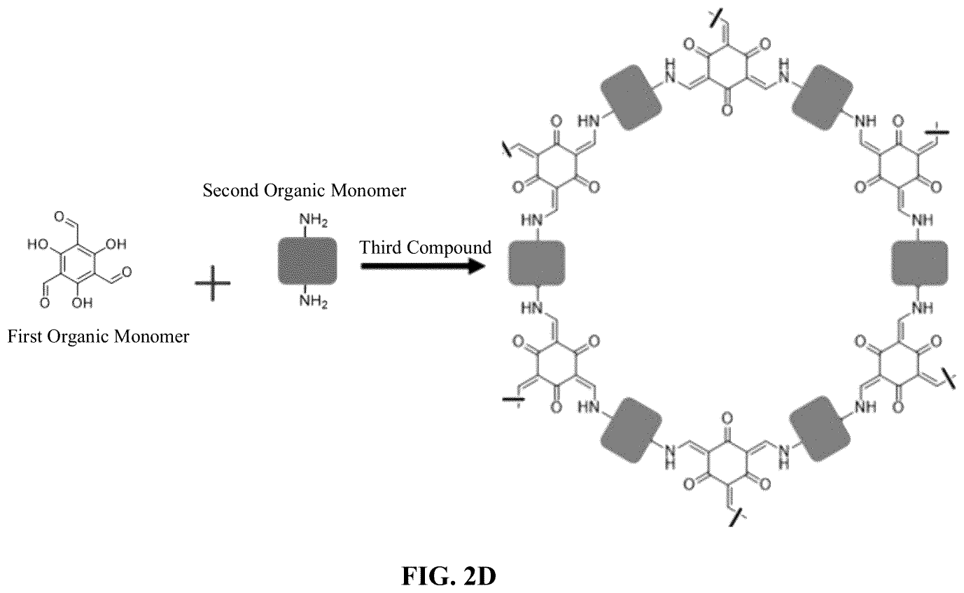

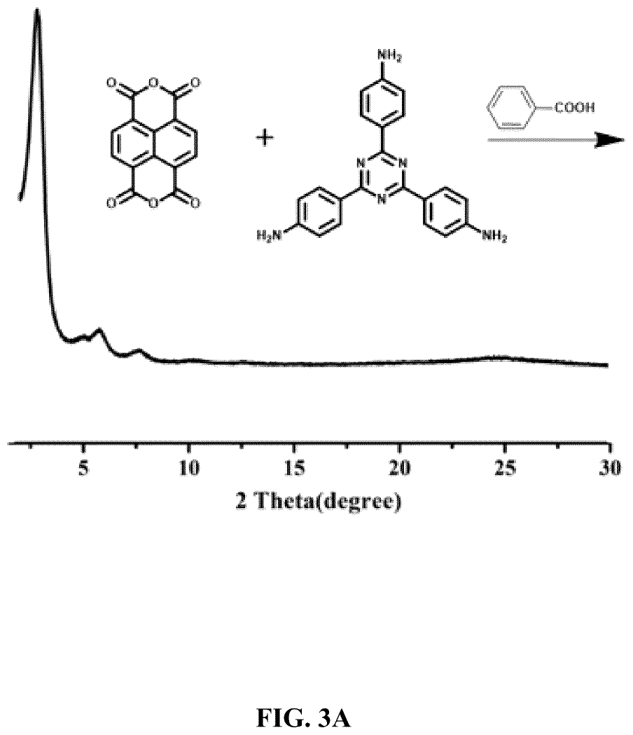

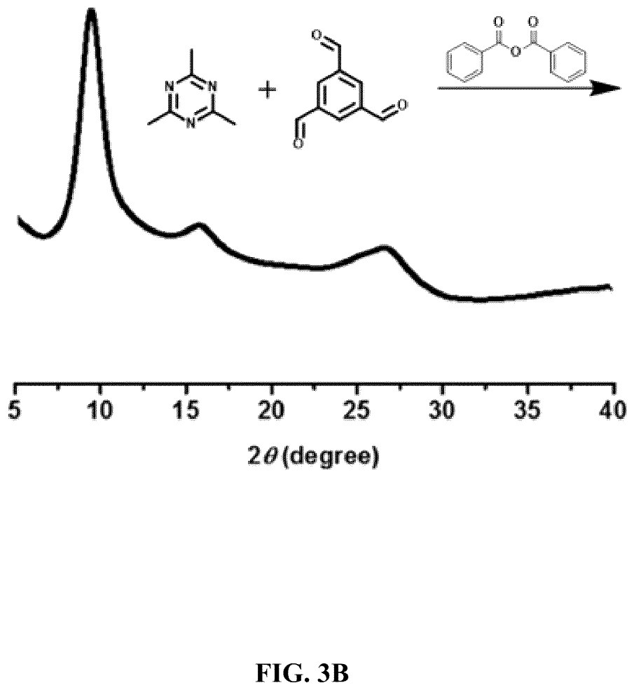

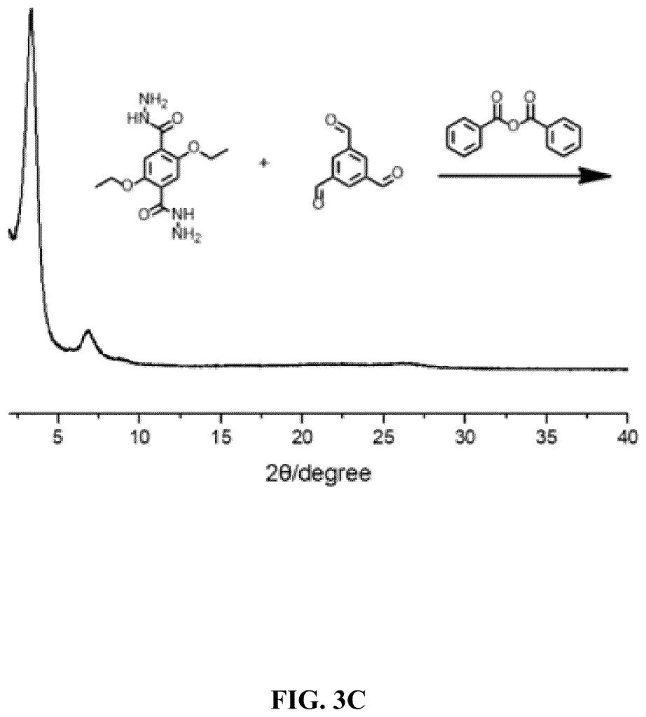

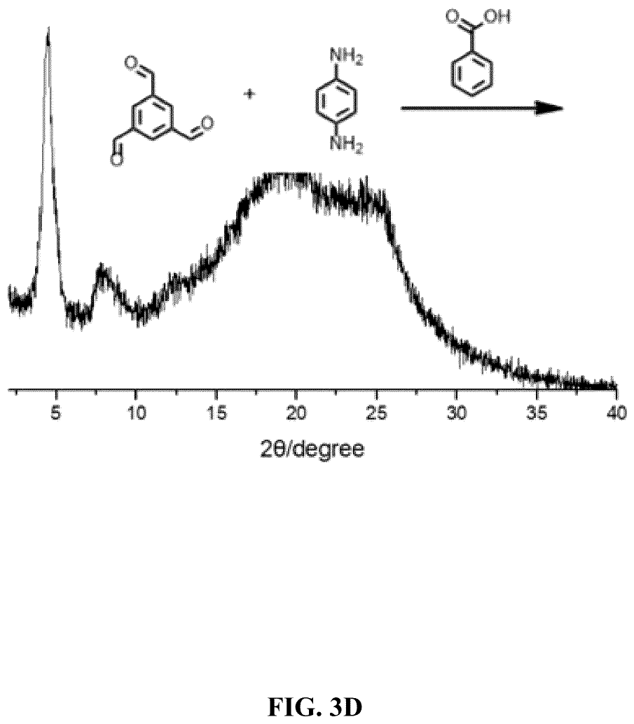

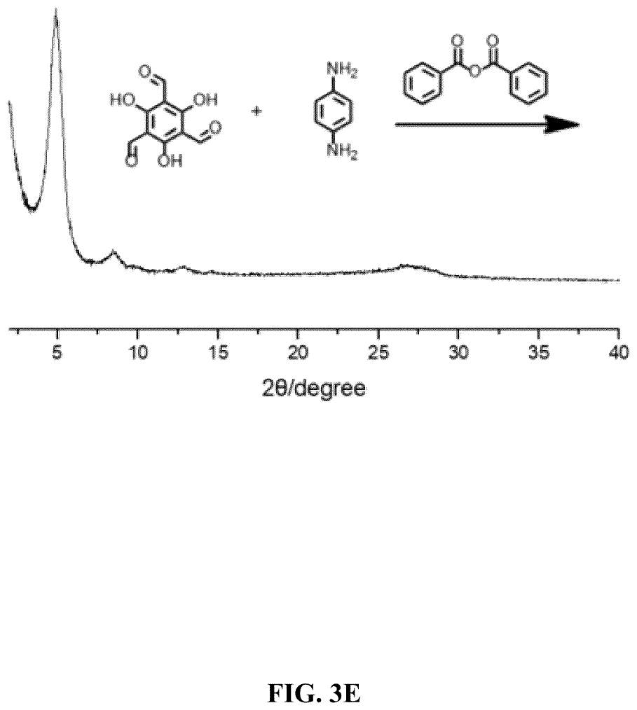

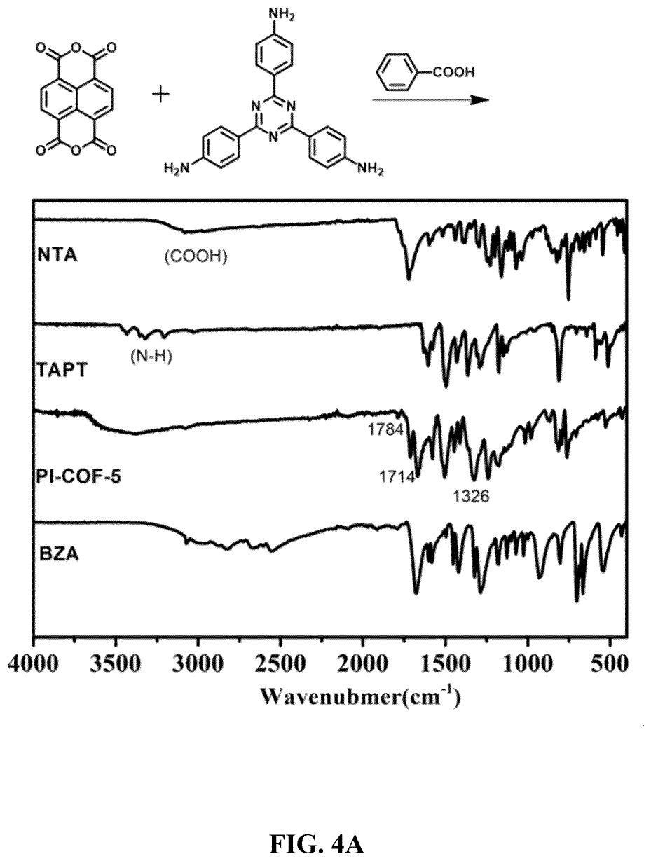

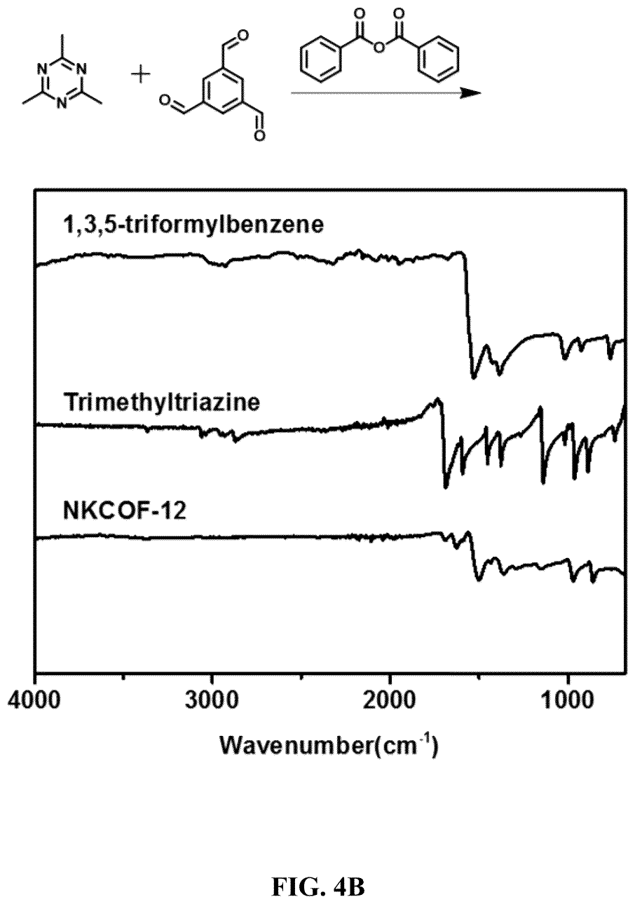

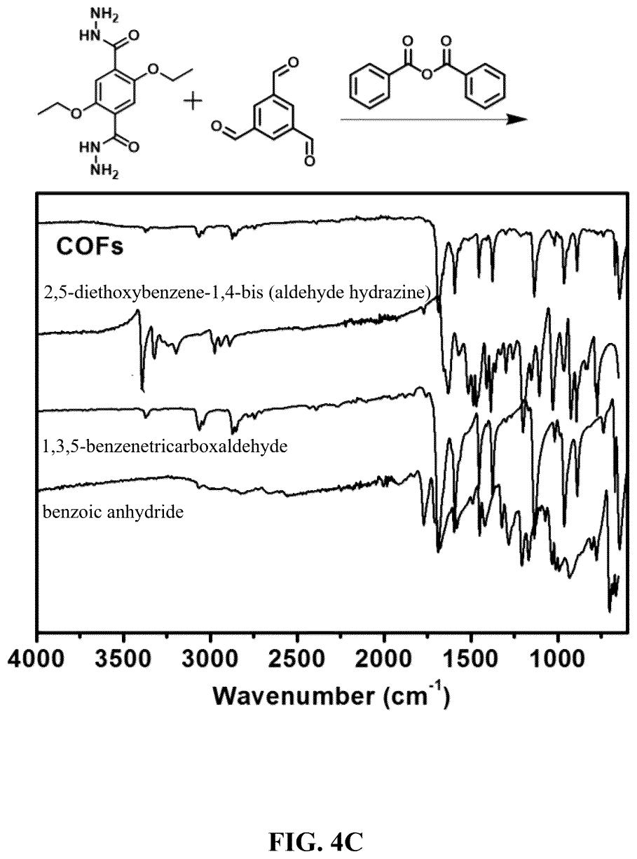

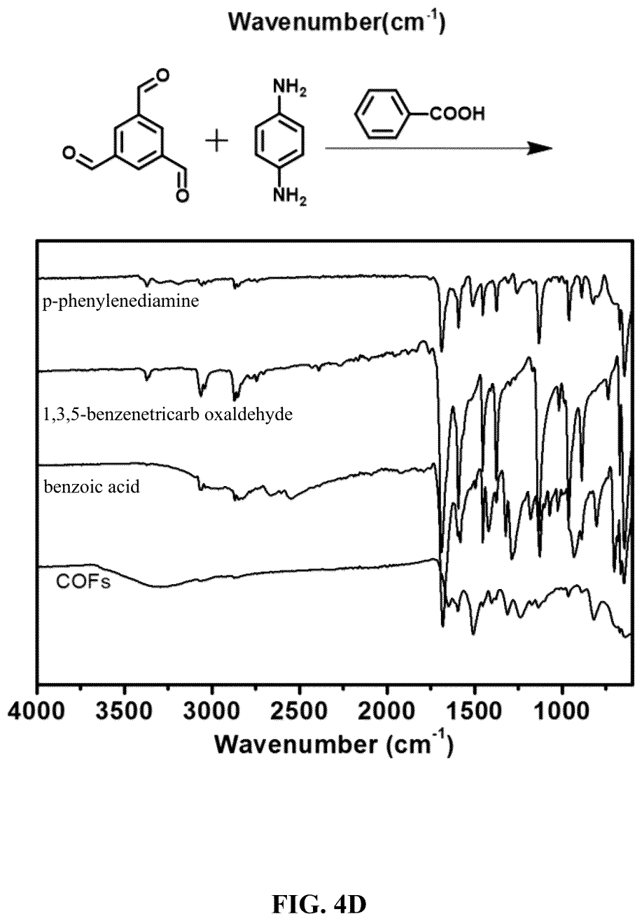

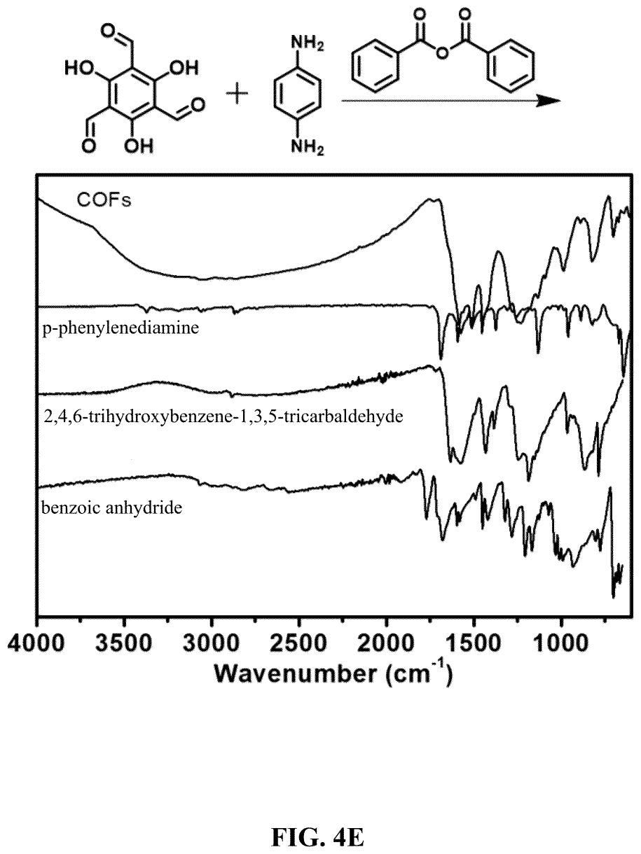

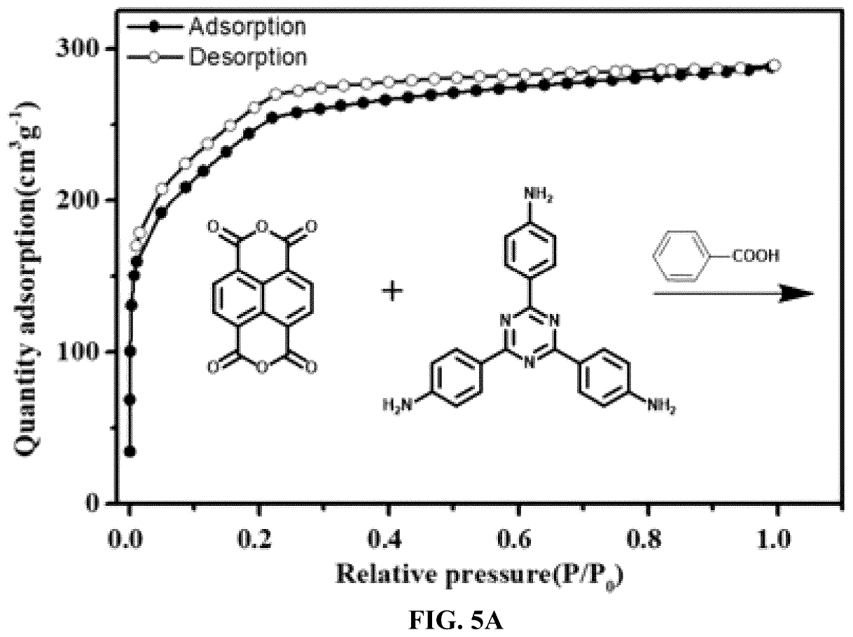

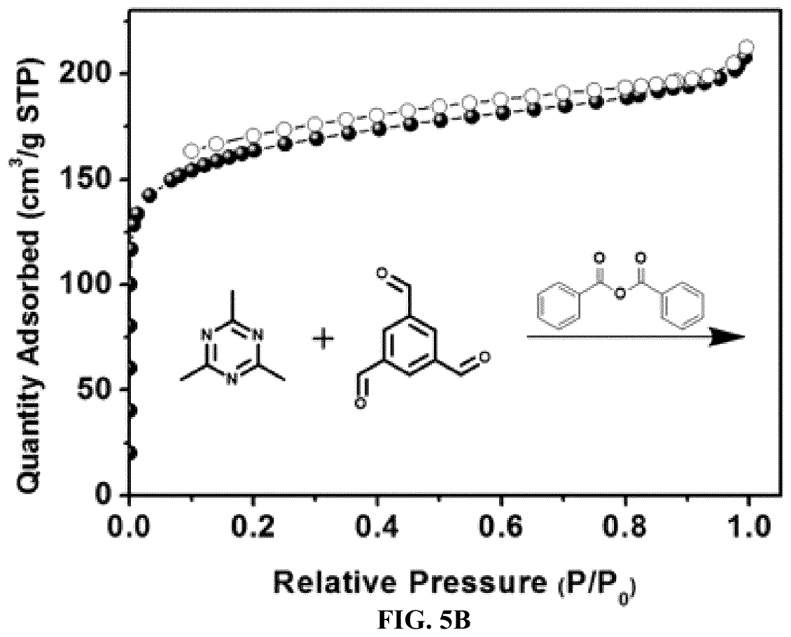

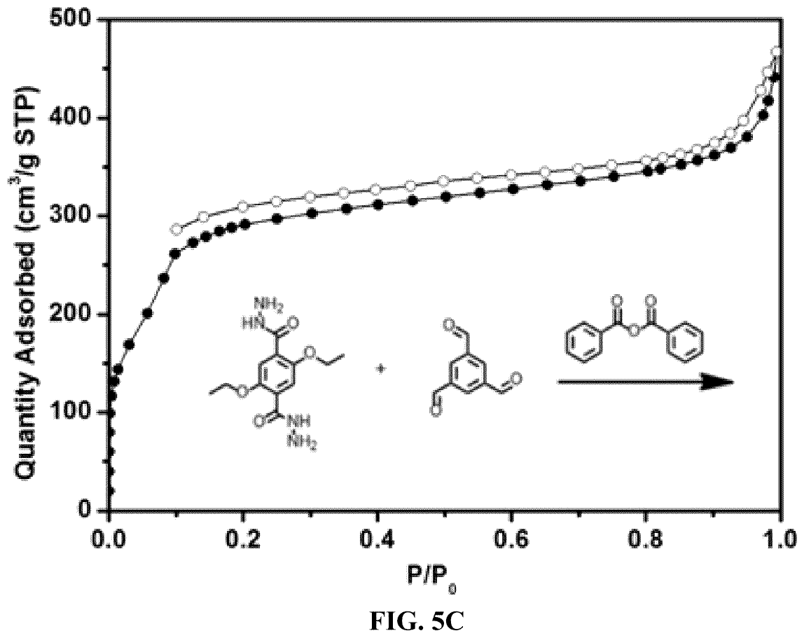

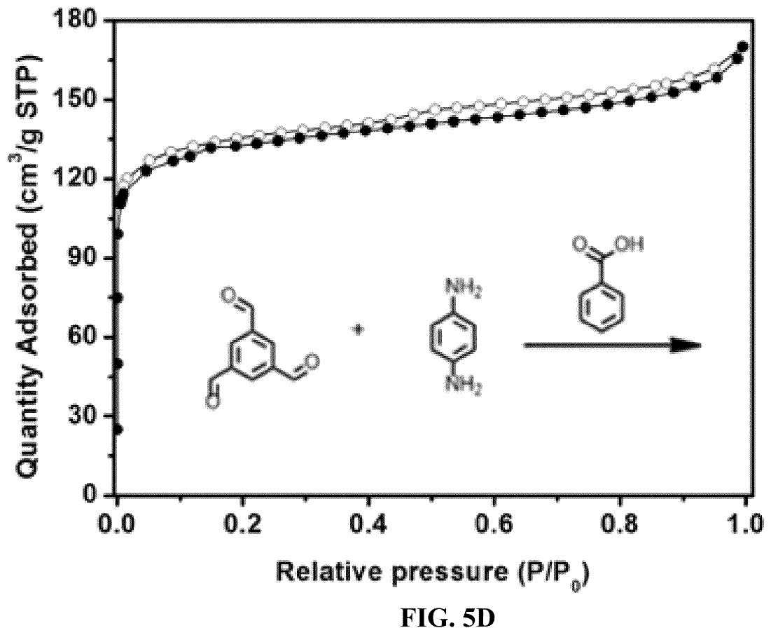

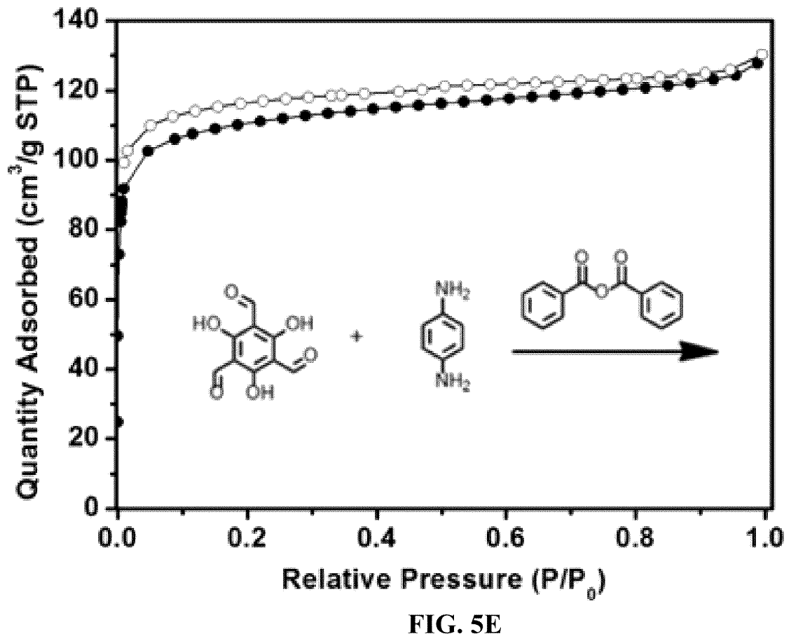

As shown in FIGS. 1A & 1B, one of naphthalene-1,4,5,8-tetracarboxylic acid dianhydride (NTCDA) (0.15 mmol, 40.23 mg) or naphthalene-1,4,5,8-tetracarboxylic acid (NTA) (0.15 mmol, 45.63 mg); 2,4,6-tris(4-aminophenyl)-1,3,5-triazine (TAFT) (0.10 mmol, 35.4 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed and carefully packed into a thick-walled glass tube that is resistant to high temperature and high pressure. After vacuuming until the pressure inside the tube reaches 0.15 mmHg, remove it from the vacuum line and seal the glass tube with the flame generated by the hydrogen oxygen machine to isolate air. The sealed glass tube is placed in a 250° C. oven for reacting for 5 days. After the reaction, solid powder of earthy yellow powder is obtained, which is soaked in DMF and CH₃OH, and then subjected to Soxhlet extraction in tetrahydrofuran solvent for 48 h, thereby obtaining powder of earthy yellow powder with mass of between 51-59 mg and yield of 74%-84%. As shown in FIG. 3A, powder X-ray testing reveals that the powder sample prepared by the reaction of naphthalene-1,4,5,8-tetracarboxylic acid dianhydride and 2,4,6-tris(4-aminophenyl)-1,3,5-triazine under catalysis of benzoic anhydride has high crystallinity. FIG. 4A further demonstrates by infrared spectroscopy that the material is imide linked COFs material. FIG. 5A shows the nitrogen isothermal adsorption-desorption curve of the material under 77K condition, with BET surface area of 894 m²/g.

### Example 2

As shown in FIGS. 1A & 1B, one of naphthalene-1,4,5,8-tetracarboxylic acid dianhydride (NTCDA) (0.15 mmol, 40.23 mg) or naphthalene-1,4,5,8-tetracarboxylic acid (NTA) (0.15 mmol, 45.63 mg); tris(4-aminophenyl amine) (TAPA) (0.10 mmol, 29.0 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed, and the other operations are the same as in embodiment 1 to obtain black powder with mass of between 51-59 mg and yield of 71%-91%.

### Example 3

As shown in FIGS. 1A & 1B, one of naphthalene-1,4,5,8-tetracarboxylic acid dianhydride (NTCDA) (0.2 mmol, 53.6 mg) or naphthalene-1,4,5,8-tetracarboxylic acid (NTA) (0.2 mmol, 60.8 mg); one of N,N,N′,N′-tetra(p-amino phenyl)p-phenylenediamine (0.1 mmol, 47.2 mg) or tetra-(4-amino phenyl)vinyl (0.1 mmol, 39.2 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.8 mmol, 97.6 mg), 4-fluorobenzoic acid (0.8 mmol, 115.29 mg) and propanoic acid (0.8 mmol, 59.2 mg) are weighed, and the other operations are the same as in embodiment 1 to obtain brown powder with yield of about 90%.

### Example 4

As shown in FIGS. 1A & 1B, one of pyromellitic dianhydride (PMDA) (0.15 mmol, 32.7 mg) or pyromellitic acid (PA) (0.15 mmol, 38.1 mg); 1,3,5-tris(4-aminophenyl)benzene (TAPB) (0.10 mmol, 35.1 mg); and one of benzoic anhydride (0.3 mmol, 67.8 mg), 4-trifluoromethylbenzoic anhydride (0.3 mmol, 108.67 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed and carefully packed into the thick-walled glass tube that is resistant to high temperature and high pressure. After vacuuming until the pressure inside the tube reaches 0.15 mmHg, remove it from the vacuum line and seal the glass tube with the flame generated by the hydrogen oxygen machine to isolate air. The sealed glass tube is placed in the 200° C. oven for reacting for 5 days. After the reaction, solid powder of orange yellow powder is obtained, which is soaked in DMF and CH₃OH, and then subjected to Soxhlet extraction in tetrahydrofuran solvent for 48 h, thereby obtaining powder of orange yellow powder with mass of between 44-52 mg and yield of about between 77%-95%.

### Example 5

As shown in FIGS. 1A & 1B, one of pyromellitic dianhydride (PMDA) (0.15 mmol, 32.7 mg) or pyromellitic acid (PA) (0.15 mmol, 38.1 mg); 2,4,6-tris(4-aminophenyl)-1,3,5-triazine (TAPT) (0.10 mmol, 35.4 mg); and one of benzoic anhydride (0.3 mmol, 67.8 mg), 4-trifluoromethylbenzoic anhydride (0.3 mmol, 108.67 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed, and the other operations are the same as in embodiment 4 to obtain faint yellow powder with mass of between 42-59 mg and yield of about between 75%-86%.

### Example 6

As shown in FIGS. 1A & 1B, one of pyromellitic dianhydride (PMDA) (0.15 mmol, 32.7 mg) or pyromellitic acid (PA) (0.15 mmol, 38.1 mg); tris(4-aminophenyl amine) (TAPA) (0.10 mmol, 29.0 mg) or 2,4,6-tris(3-hydroxyl-4-amino phenyl)-1,3,5-triazine (0.10 mmol, 40.2 mg); and one of benzoic anhydride (0.3 mmol, 67.8 mg), 4-trifluoromethylbenzoic anhydride (0.3 mmol, 108.67 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed, and the other operations are the same as in embodiment 4 to obtain purple black powder with mass of between 42-52 mg and yield of about between 75%-91%.

### Example 7

As shown in FIGS. 1A & 1B, one of pyromellitic dianhydride (PMDA) (0.2 mmol, 43.6 mg) or pyromellitic acid (PA) (0.2 mmol, 50.8 mg); one of N,N,N′,N′-tetra(p-amino phenyl)p-phenylenediamine (0.1 mmol, 47.2 mg) or tetra-(4-amino phenyl)vinyl (0.1 mmol, 39.2 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.8 mmol, 97.6 mg), 4-fluorobenzoic acid (0.8 mmol, 115.29 mg) and propanoic acid (0.8 mmol, 59.2 mg) are weighed, and the other operations are the same as in embodiment 4 to obtain brown powder with yield of about 90%.

### Example 8

As shown in FIGS. 1A & 1B, one of naphthalene-1,4,5,8-tetracarboxylic acid dianhydride (NTCDA) (0.15 mmol, 40.23 mg) or naphthalene-1,4,5,8-tetracarboxylic acid (NTA) (0.15 mmol, 45.63 mg); 1,3,5-tris(4-aminophenyl)benzene (TAPB) (0.10 mmol, 35.1 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed and carefully packed into the thick-walled glass tube that is resistant to high temperature and high pressure. After vacuuming until the pressure inside the tube reaches 0.15 mmHg, remove it from the vacuum line and seal the glass tube with the flame generated by the hydrogen oxygen machine to isolate air. The sealed glass tube is placed in the 250° C. oven for reacting for 3 days. After the reaction, black solid powder is obtained, which is soaked in DMF and CH₃OH, and then subjected to Soxhlet extraction in tetrahydrofuran solvent for 48 hours, thereby obtaining black powder with mass of between 43-54 mg and yield of about between 68%-83%.

### Example 9

As shown in FIGS. 1A & 1B, one of pyromellitic dianhydride (PMDA) (0.15 mmol, 32.7 mg) or pyromellitic acid (PA) (0.15 mmol, 38.1 mg), 5″-(4′-amino[1,1′-biphenyl]-4-yl)[1,1′:4′,1″:3″,1′″:4′″,1″″-quinquephenyl]-4,4′″-diamine (TABPB) (0.1 mmol, 57.9 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed and carefully pack into the thick-walled glass tube that is resistant to high temperature and high pressure. After vacuuming until the pressure inside the tube reaches 0.15 mmHg, remove it from the vacuum line and seal the glass tube with the flame generated by the hydrogen oxygen machine to isolate air. The sealed glass tube is placed in the 250° C. oven for reacting for 3 days. After the reaction, solid powder of earthy yellow powder is obtained, which is soaked in DMF and CH₃OH, and then subjected to Soxhlet extraction in tetrahydrofuran solvent for 48 h, thereby obtaining black powder with mass of about 46-53 mg and yield of about between 67%-76%.

### Example 10

As shown in FIGS. 1A & 1B, one of pyromellitic dianhydride (PMDA) (0.15 mmol, 32.7 mg) or pyromellitic acid (PA) (0.15 mmol, 38.1 mg); 4′,4′″,4′″″-(1,3,5-triazine-2,4,6-triyl)tris(([[1,1′-biphenyl]-4-amine)) (TTBT) (0.1 mmol, 58.3 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed, and the other operations are the same as in embodiment 9 to obtain deep yellow powder with mass of about 52-68 mg and yield of about between 75%-83%.

### Example 11

As shown in FIGS. 1A & 1B, one of naphthalene-1,4,5,8-tetracarboxylic acid dianhydride (NTCDA) (0.15 mmol, 40.23 mg) or naphthalene-1,4,5,8-tetracarboxylic acid (NTA) (0.15 mmol, 45.63 mg); 5″-(4′-amino[1,1′-biphenyl]-4-yl)[1,1′:4′,1″:3″,1′″:4′″,1″″-quinquephenyl]-4,4″″-diamine (TABPB) (0.1 mmol, 57.9 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed, and the other operations are the same as in embodiment 9 to obtain black powder with mass of about 43-59 mg and yield of about between 63%-79%.

### Example 12

As shown in FIGS. 1A & 1B, one of naphthalene-1,4,5,8-tetracarboxylic acid dianhydride (NTCDA) (0.15 mmol, 40.23 mg) or naphthalene-1,4,5,8-tetracarboxylic acid (NTA) (0.15 mmol, 45.63 mg); 4′,4′″,4′″″-(1,3,5-triazine-2,4,6-triyl)tris(([[1,1′-biphenyl]-4-amine)) (TTBT) (0.1 mmol, 58.3 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed, and the other operations are the same as in embodiment 9 to obtain black powder with mass of about 52-63 mg and yield of about between 75%-81%.

### Example 13

As shown in FIGS. 1A & 1B, one of pyromellitic dianhydride (PMDA) (0.15 mmol, 32.7 mg) or pyromellitic acid (PA) (0.15 mmol, 38.1 mg); 2,7,12-triamino-5H-diindolyl[1,2-a:1′,2′-c]fluorene-5,10,15-trione (TRO) (0.1 mmol, 42.9 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed, and the other operations are the same as in embodiment 9 to obtain brown powder with mass of about 47-52 mg and yield of about between 63%-71%.

### Example 14

As shown in FIGS. 1A & 1B, one of naphthalene-1,4,5,8-tetracarboxylic acid dianhydride (NTCDA) (0.15 mmol, 40.23 mg) or naphthalene-1,4,5,8-tetracarboxylic acid (NTA) (0.15 mmol, 45.63 mg); 2,7,12-triamino-5H-diindolyl[1,2-a:1′,2′-c]fluorene-5,10,15-trione (TRO) (0.1 mmol, 42.9 mg); and one of benzoic anhydride (0.225 mmol, 50.9 mg), 4-trifluoromethylbenzoic anhydride (0.225 mmol, 81.50 mg), acetic anhydride (0.5 mmol, 51.04 mg), benzoic acid (0.6 mmol, 73.28 mg), 4-fluorobenzoic acid (0.6 mmol, 86.47 mg) and propanoic acid (0.6 mmol, 44.4 mg) are weighed, and the other operations are the same as in embodiment 9 to obtain brown powder with mass of about 43-55 mg and yield of about between 61%-73%.

### Example 15

As shown in formula 2, 0.2 mmol of one of 2,4,6-trimethylpyridine-3,5-diformonitrile (24.2 mg); 2,4,6-tricyano-1,3,5-trimethylbenzene (39.0 mg) and 2,4,6-trimethyl-1,3,5-triazine (24.6 mg); and benzoic anhydride (0.6 mmol, 135 mg) or benzoic acid (0.12 mmol 146.5 mg), and 0.2 mmol of one of 1,3,5-benzenetricarboxaldehyde (32.4 mg); 1,3,5-tris(4′-aldehyde [1,1′-biphenyl]-4-yl)benzene (123.8 mg); 1,3,5-tris(p-aldehyde phenyl)benzene (78.1 mg); 4,4,4′-[benzene-1,3,5-triyl tris(acetylene-2,1-diyl)]tribenzaldehyde (92.5 mg); 2,4,6-tris(4-aldehyde phenyl)-1,3,5-triazine (78.7 mg); and 2,4,6-tris(4-aldehyde-biphenyl-4-yl)-1,3,5-triazine (124.3 mg) are selected and packed into the thick-walled glass tube that is resistant to high temperature and high pressure. After vacuuming until the pressure inside the tube reaches 0.15 mmHg, remove it from the vacuum line and seal the glass tube with the flame generated by the hydrogen oxygen machine to isolate air. The sealed glass tube is placed in the 180° C. oven for reacting for 5 days. After the reaction, solid powder is obtained, which is soaked in DMF and CH₃OH, and then subjected to Soxhlet extraction in tetrahydrofuran solvent at 100° C. for 48 h, thereby obtaining whole block of COF material ranging from milky white to orange yellow with mass of about 52 mg and yield of about between 85% to 95%. As shown in FIG. 3B, powder X-ray testing reveals that the powder sample prepared by the reaction of 2,4,6-trimethyl-1,3,5-triazine and 1,3,5-benzenetricarboxaldehyde under catalysis of benzoic anhydride has high crystallinity. FIG. 4B further demonstrates by infrared spectroscopy that the material is C═C double bond linked COFs material. FIG. 5A shows the nitrogen isothermal adsorption-desorption curve of the material under 77K condition, with BET surface area of 536 m²/g.

### Example 16

As shown in formula 2, 0.02 mmol of one of 2,4,6-trimethylpyridine-3,5-diformonitrile (24.2 mg); 2,4,6-tricyano-1,3,5-trimethylbenzene (39.0 mg) and 2,4,6-trimethyl-1,3,5-triazine (24.6 mg); and benzoic anhydride (0.6 mmol, 135 mg) or benzoic acid (1.2 mmol, 146.5 mg) and 0.3 mmol of one of terephthalaldehyde (40.2 mg); 1,4-bis(4-aldehyde phenyl)benzene (85.9 mg); 4,4′-biphenyl formaldehyde (63 mg); 1,2-bis(4′-aldehyde phenyl)acetylene (70.3 mg); 4,4′-(1,3-butadiyne-1,4-diyl)dibenzaldehyde (77.5 mg); 2,5-bimethoxyl-1,4-terephthalaldehyde (58.2 mg); 4,7-bis(4-aldehyde phenyl)benzofuran (97.8 mg); 4,7-bis(4-aldehyde phenyl)benzothiophene (102.7 m mg); and 4,7-bis(4-aldehyde phenyl)benzoselenophene (116.7 mg) are selected and packed into the thick-walled glass tube that is resistant to high temperature and high pressure. After vacuuming until the pressure inside the tube reaches 0.15 mmHg, remove it from the vacuum line and seal the glass tube with the flame generated by the hydrogen oxygen machine to isolate air. The sealed glass tube is placed in the 180° C. oven for reacting for 5 days. After the reaction, solid powder is obtained, which is soaked in DMF and CH₃OH, and then subjected to Soxhlet extraction in tetrahydrofuran solvent at 100° C. for 48 h, thereby obtaining milky white, yellow and brownish red whole block of COF material with yield of about between 83% to 95%.

### Example 17

As shown in formula 2, 0.03 mmol of second monomer (mainly including one of 2,5-dimethylpyrazine (32.4 mg); 3,6-dimethylpyridazine (32.4 mg); 2,5-dimethylterephthalonitrile (46.9 mg)); and benzoic anhydride (0.6 mmol, 135 mg) or benzoic acid (1.2 mmol 146.5 mg) and 0.2 mmol of one of 1,3,5-benzenetricarboxaldehyde (32.4 mg); 1,3,5-tris(4′-aldehyde [1,1′-biphenyl]-4-yl)benzene (123.8 mg); 1,3,5-tris(p-aldehyde phenyl)benzene (78.1 mg); 4,4,4′-[benzene-1,3,5-triyl tris(acetylene-2,1-diyl)]tribenzaldehyde (92.5 mg); 2,4,6-tris(4-aldehyde phenyl)-1,3,5-triazine (78.7 mg); and 2,4,6-tris(4-aldehyde-biphenyl-4-yl)-1,3,5-triazine (124.3 mg) are selected and packed into the thick-walled glass tube that is resistant to high temperature and high pressure. After vacuuming until the pressure inside the tube reaches 0.15 mmHg, remove it from the vacuum line and seal the glass tube with the flame generated by the hydrogen oxygen machine to isolate air. The sealed glass tube is placed in the 200° C. oven for reacting for 5 days. After the reaction, orange yellow solid powder is obtained, which is soaked in DMF and CH₃OH, and then subjected to Soxhlet extraction in tetrahydrofuran solvent at 100° C. for 48 h, thereby obtaining milky white, yellow and brownish red whole block of COF material with yield of about between 80% to 95%.

### Example 18

As shown in formula 3, 0.04 mmol of first monomer (mainly including one of 1,3,5-tris(4′-aldehyde [1,1′-biphenyl]-4-yl)benzene (24.7 mg); 1,3,5-tris(p-aldehyde phenyl)benzene (15.6 mg); 2,4,6-tris(4-aldehyde phenyl)-1,3,5-triazine (15.7 mg); 4,4″,4′″-(1,3,5-triazine-2,4,6-triyl) tris(([1,1-biphenyl]-4-formaldehyde)) (24.9 mg); and 1,3,5-benzenetricarboxaldehyde (6.5 mg)) is selected and packed into the thick-walled glass tube that is resistant to high temperature and high pressure; and then 0.06 mmol of second monomer (mainly including one of terephthalic dihydrazide (11.7 mg); 2,5-diethoxybenzene-1,4-bis(aldehyde hydrazine) (16.9 mg); 2,5-bis(allyloxy)p-phenylhydrazide (18.4 mg)) is weighed and packed into the glass tube; and then 0.06 mmol of third compound (one of benzoic anhydride, benzimidazole, benzoic acid) is weighed and packed into the glass tube. After vacuuming until the pressure inside the tube reaches 0.15 mmHg, remove it from the vacuum line and seal the glass tube with the flame generated by the hydrogen oxygen machine to isolate air. The sealed glass tube is placed in the 120° C. oven for reacting for 3 days. After the reaction, solid powder is obtained, which is soaked in DMF and CH₃OH, and then subjected to Soxhlet extraction in tetrahydrofuran solvent at 100° C. for 48 h, thereby obtaining relatively pure COF material with yield of about between 80% to 95%. As shown in FIG. 3C, powder X-ray testing reveals that the powder sample prepared by the reaction of 1,3,5-benzenetricarboxaldehyde and 2,5-diethoxybenzene-1,4-bis(aldehyde hydrazine) under catalysis of benzoic anhydride has high crystallinity. FIG. 4C further demonstrates by infrared spectroscopy that the material is hydrazone bond linked COFs material. FIG. 5C shows the nitrogen isothermal adsorption-desorption curve of the material under 77K condition, with BET surface area of 951 m²/g.

### Example 19

As shown in formula 3, 0.04 mmol of benzene-1,3,5-tricarbohydrazide (10.1 mg) is selected and packed into the thick-walled glass tube that is resistant to high temperature and high pressure; and then 0.06 mmol of first organic monomer (mainly including one of terephthalaldehyde (8 mg); 1,4-bis(4-aldehyde phenyl)benzene (17.2 mg); 4,4′-biphenyl formaldehyde (12.6 mg); 1,2-bis(4′-aldehyde phenyl)acetylene (14.1 mg); 4,4′-(1,3-butadiyne-1,4-diyl)dibenzaldehyde (15.5 mg)) is weighed and packed into the glass tube; and then 0.06 mmol of third compound (one of benzoic anhydride, benzimidazole, benzoic acid) is weighed and packed into the glass tube. After vacuuming until the pressure inside the tube reaches 0.15 mmHg, remove it from the vacuum line and seal the glass tube with the flame generated by the hydrogen oxygen machine to isolate air. The sealed glass tube is placed in the 120° C. oven for reacting for 3 days. After the reaction, solid powder is obtained, which is soaked in DMF and CH₃OH, and then subjected to Soxhlet extraction in tetrahydrofuran solvent at 100° C. for 48 h, thereby obtaining relatively pure COF material with yield of about between 80% to 95%.

### Example 20

As shown in formula 4, 0.04 mmol of aldehyde monomer of the first organic monomer (mainly including one of 1,3,5-tris(p-aldehyde phenyl)benzene; 2,4,6-tris(4-aldehyde phenyl)-1,3,5-triazine; 1,3,5-benzenetricarboxaldehyde; 2-hydroxyl-1,3,5-benzenetrialdehyde; 2,4-dihydroxyl-1,3,5-benzenetricarboxaldehyde) is selected and packed into the thick-walled glass tube that is resistant to high temperature and high pressure; and then 0.06 mmol of amine monomer of second organic monomer (including one of p-phenylenediamine; 2,5-diaminopyridine; benzidine; 4,4′-diaminoterphenyl; hydrazine hydrate) is weighed and packed into the glass tube; and then 0.06 mmol of third compound (one of benzoic anhydride, benzimidazole, benzoic acid) is weighed and packed into the glass tube. After vacuuming until the pressure inside the tube reaches 0.15 mmHg, remove it from the vacuum line and seal the glass tube with the flame generated by the hydrogen oxygen machine to isolate air. The sealed glass tube is placed in the 120° C. oven for reacting for 3 days. After the reaction, solid powder is obtained, which is soaked in DMF and CH₃OH, and then subjected to Soxhlet extraction in tetrahydrofuran solvent at 100° C. for 48 h, thereby obtaining relatively pure COF material with yield of about between 80% to 95%. As shown in FIG. 3D, powder X-ray testing reveals that the powder sample prepared by the reaction of 1,3,5-benzenetricarboxaldehyde and p-phenylenediamine under catalysis of benzoic acid has high crystallinity. FIG. 4D further demonstrates by infrared spectroscopy that the material is imide bond linked COFs material. FIG. 5D shows the nitrogen isothermal adsorption-desorption curve of the material under 77K condition, with BET surface area of 401 m²/g.

### Example 21

As shown in formula 4, 0.04 mmol of amine monomer of second organic monomer (mainly including one of 1,3,5-tris(4-aminophenyl)benzene; 2,4,6-tris(4-aminophenyl)-1,3,5-triazine; tris(4-aminophenyl)amine) is selected and packed into the thick-walled glass tube that is resistant to high temperature and high pressure; and then 0.06 mmol of aldehyde monomer of first organic monomer (including one of terephthalaldehyde; 4,4′-biphenyl formaldehyde 1,4-bis(4-aldehyde phenyl)benzene; 1,2-bis(4′-aldehyde phenyl)acetylene) is weighed and packed into the glass tube; and then 0.06 mmol of third compound (one of benzoic anhydride, benzimidazole, benzoic acid) is weighed and packed into the glass tube. After vacuuming until the pressure inside the tube reaches 0.15 mmHg, remove it from the vacuum line and seal the glass tube with the flame generated by the hydrogen oxygen machine to isolate air. The sealed glass tube is placed in the 120° C. oven for reacting for 3 days. After the reaction, solid powder is obtained, which is soaked in DMF and CH₃OH, and then subjected to Soxhlet extraction in tetrahydrofuran solvent at 100° C. for 48 hours, thereby obtaining relatively pure COF material with yield of about between 80% to 95%.

### Example 22

As shown in formula 5, 0.04 mmol of 2,4,6-trihydroxyl-1,3,5-benzenetricarboxaldehyde (8.4 mg) is selected and packed into the thick-walled glass tube that is resistant to high temperature and high pressure; and then 0.06 mmol of second organic monomer (including one of p-phenylenediamine; 2,5-diaminopyridine; benzidine; 4,4′-diaminoterphenyl; hydrazine hydrate) is weighed and packed into the glass tube; and then 0.06 mmol of third compound (one of benzoic anhydride, benzimidazole, benzoic acid) is weighed and packed into the glass tube. After vacuuming until the pressure inside the tube reaches 0.15 mmHg, remove it from the vacuum line and seal the glass tube with the flame generated by the hydrogen oxygen machine to isolate air. The sealed glass tube is placed in the 120° C. oven for reacting for 3 days. After the reaction, solid powder is obtained, which is soaked in DMF and CH₃OH, and then subjected to Soxhlet extraction in tetrahydrofuran solvent at 100° C. for 48 hours, thereby obtaining relatively pure COF material with yield of about between 80% to 95%. As shown in FIG. 3E, powder X-ray testing reveals that the powder sample prepared by the reaction of 2,4,6-trihydroxyl-1,3,5-benzenetricarboxaldehyde and p-phenylenediamine under catalysis of benzoic acid has high crystallinity. FIG. 4E further demonstrates by infrared spectroscopy that the material is Ketoenamine COFs material. FIG. 5E shows the nitrogen isothermal adsorption-desorption curve of the material under 77K condition, with BET surface area of 334 m²/g.

### Example 23

As shown in formula 5, 0.04 mmol of 2,4,6-trihydroxyl-1,3,5-benzenetricarboxaldehyde (8.4 mg) is selected and packed into the thick-walled glass tube that is resistant to high temperature and high pressure; and then 0.06 mmol of second monomer (including one of 1,3,5-tris(4-aminophenyl)benzene; 2,4,6-tris(4-aminophenyl)-1,3,5-triazine; tris(4-aminophenyl)amine) is weighed and packed into the glass tube; 0.06 mmol of third compound (one of benzoic anhydride, benzimidazole, benzoic acid) is weighed and packed into the glass tube. After vacuuming until the pressure inside the tube reaches 0.15 mmHg, remove it from the vacuum line and seal the glass tube with the flame generated by the hydrogen oxygen machine to isolate air. The sealed glass tube is placed in the 120° C. oven for reacting for 3 days. After the reaction, solid powder is obtained, which is soaked in DMF and CH₃OH, and then subjected to Soxhlet extraction in tetrahydrofuran solvent at 100° C. for 48 hours, thereby obtaining relatively pure COF material with yield of about between 80% to 95%.

Finally, it should be noted that the above is only a preferred embodiment of the present invention and is not intended to impose any formal limitations on the present invention. Any research and technical personnel familiar with this field who, without departing from the scope of the technical solution of the present invention, make non-innovative changes and modifications to the technical solution of the present invention using the above content, such as only changing the proportion of raw materials and reagents added, reaction time and operating process, should be included in the scope of protection of the present invention.

What is claimed is:

1-10. (canceled)

11. A method for making a covalent organic framework material with solid-phase synthesis, comprising the step of:
preparing a first organic monomer and a second organic monomer in a condensation reaction under a solvent-free condition aided by a catalyst, wherein:
the covalent organic framework material is configured with one of olefin linkage, imide linkage, boronate ester linkage, boroxine linkage, imine linkage, azine linkage, Ketoenamine linkage, hydrazone linkage and triazine linkage;
the first organic monomer includes one of a carboxylic acid anhydride functional group, a carboxylic acid functional group and an aldehyde functional group;
the second organic monomer includes one of an amino functional group and an active methyl functional group; and
the catalyst includes one of an anhydride functional group, a carboxylic acid functional group, an imidazole functional group and a hydroxyl functional group.

12. The method in claim 11, wherein:
the first organic monomer includes one of 2-connector building blocks which include a carboxylic acid anhydride functional group, 2-connector building blocks which include a carboxylic acid functional group, 2-connector building blocks which include an aldehyde functional group and 3-connector building blocks which include an aldehyde functional group; and
the second organic monomer includes one of 2-connector building blocks which include an amino functional group, 3-connector building blocks which include an amino functional group, 4-connector building blocks which include an amino functional group, 2-connector building block which include an active methyl functional group and 3-connector building blocks which include an active methyl functional group.

13. The method in claim 11, further comprising the steps of:
growing the covalent organic framework material in-situ;
adding into a closed system the catalyst, the first organic monomer and the second organic monomer; and
heating the system to trigger polymerization.

14. The method in claim 11, further comprising the steps of:
adding the catalyst to the first organic monomer and the second organic monomer to obtain under the solvent-free condition a first product;
purifying the first product to obtain a second product; and
subjecting the second product to supercritical carbon dioxide or heating the second product in a vacuum to obtain the covalent organic framework material.

15. The method in claim 11, wherein:
the first organic monomer includes one of: a phenylboronic acid; benzaldehyde; 2,4,6-trihydroxy benzene-1,3,5-trioxin; phthalic anhydride; hydroxyl propanone; phenyldione; and a dicarboxylic acid; and
the second organic monomer includes one of: pyrocatechol; phenylamine; benzoyl hydrazine; hydrazine hydrate; cyanobenzene; phenylacetonitrile; dimethylpyrazine; benzamidine; o-phenylenediamin; and triamine.

16. The method in claim 11, wherein:
the first organic monomer includes one of benzaldehyde, benzoic anhydride and a phthalic acid;
the second organic monomer includes one of phenylamine, benzoylhydrazine, hydrazine hydrate and active methyl;
when the first organic monomer includes a 2-connector building block, the 2-connector building block includes linear molecules;
when the second organic monomer includes a 2-connector building block, the 2-connector building block includes linear molecules;
when the first organic monomer includes a 3-connector building block, the 3-connector building block includes a 120° angle;
when the second organic monomer includes a 3-connector building block, the 3-connector building block includes a 120° angle; and
when the second organic monomer includes a 4-connector building block, the 4-connector building block includes a 120° angle.

17. The method in claim 16, wherein:
the first organic monomer includes one of 2-connector building blocks which include benzaldehyde, 3-connector building blocks which include benzaldehyde, 2-connector building blocks which include benzoic anhydride and 2-connector building blocks which include a phthalic acid; and
the second organic monomer includes one of 2-connector building blocks which include phenylamine, 3-connector building blocks which include phenylamine, 4-connector building blocks which include phenylamine, 2-connector building blocks which include benzoylhydrazine, 3-connector building blocks which include benzoylhydrazine, hydrazine hydrate, 2-connector building blocks which include active methyl and 3-connector building blocks which include active methyl.

18. The method in claim 11, wherein:
the catalyst includes, with or without substitution, one of benzoic anhydride, 4-trifluoromethyl benzoic anhydride, phenylacetic anhydride, acetic anhydride, trifluoroacetic anhydride, benzoic acid, 4-fluorobenzoic acid, 4-bromobenzoic acid, propanoic acid, aromatic acid, imidazole, benzimidazole and phenol.

19. The method in claim 11, wherein:
the first organic monomer includes one of: terephthalaldehyde; 1,4-bis(4-aldehyde phenyl)benzene; 4,4-biphenyl formaldehyde; 4,7-bis(4-aldehyde phenyl)benzofuran; 4,7-bis(4-aldehyde phenyl)benzothiophene; 4,7-bis(4-aldehyde phenyl)benzoselenophenol; 1,2-bis(4-formyl phenyl)acetylene; 4,4-(1,3-butadiyne-1,4-diyl)dibenzaldehyde; 2,5-bimethoxyl-1,4-terephthalaldehyde; 1,3,5-benzenetricarboxaldehyde; 2-hydroxyl-1,3,5-benzenetrialdehyde; 2,4-dyhydroxyl-1,3,5-benzenetricarboxaldehyde; 2,4,6-trihydroxyl-1,3,5-benzenetricarboxaldehyde; 1,3,5-tris(4-aldehyde [1,1-biphenyl]-4-yl)benzene; 1,3,5-tris(p-formyl phenyl)benzene; 4,4,4-[benzene-1,3,5-triyl tris(acetylene-2,1-diyl)]tribenzaldehyde; 2,4,6-tris(4-aldehyde phenyl)-1,3,5-triazine; 4,4″,4″-(1,3,5-triazine-2,4,6-triyl) tris(([1,1-biphenyl]-4-formaldehyde)); and 2,4,6-tris(4-formyl-biphenyl-4-yl)-1,3,5-triazine; and
the second organic monomer includes one of: 2,5-dimethylpyrazine; tetramethylpyrazine; 3,6-dimethylpyridazine; 2,5-dimethylterephthalonitrile; 2,4,6-trimethyl-1,3,5-triazine; 2,4,6-trimethylpyridine; 2,4,6-trimethyl-pyrimidine; 2,4,6-trimethyl-pyrimidine-5-formonitrile; 2,4,6-trimethyl-pyrimidine-3,5-diformonitrile; 2,4,6-tricyano-1,3,5-trimethylbenzene; and 2,2′-dipyridyl-5,5′-diacetonitrile.

20. The method in claim 19, further comprising the steps of:
preparing the first organic monomer which includes 3-connector building blocks; and
preparing the second organic monomer which includes 2-connector building blocks.

21. The method in claim 19, further comprising the steps of:
preparing the first organic monomer which includes 2-connector building blocks; and
preparing the second organic monomer which includes 3-connector building blocks.

22. The method in claim 11, wherein:
the first organic monomer includes one of pyromelliticdianhydride (PMDA); naphthalene-1,4,5,8-tetracarboxylic acid dianhydride (NTCDA); pyromellitic acid (PA); naphthalene-1,4,5,8-tetracarboxylic acid (NTA); terephthalaldehyde; 1,4-bis(4-aldehyde phenyl)benzene; 4,4-biphenyldicarboxaldehyde; 1,2-bis(4-formyl phenyl)acetylene, 4,4-(1,3-butadiyne-1,4-diyl)dibenzaldehyde; 2,5-bimethoxyl-1,4-terephthalaldehyde; benzenetricarboxaldehyde; 2-hydroxyl-1,3,5-benzenetrialdehyde; 2,4-dyhydroxyl-1,3,5-benzenetricarboxaldehyde; 2,4,6-trihydroxyl-1,3,5-benzenetricarboxaldehyde; 1,3,5-tris(4′-aldehyde [1,1′-biphenyl]-4-yl)benzene; 1,3,5-tris(p-formyl phenyl)benzene; 4,4,4-[benzene-1,3,5-triyltris(acetylene-2,1-diyl)]tribenzaldehyde; 2,4,6-tris(4-aldehyde phenyl)-1,3,5-triazine; 4,4″,4′″-(1,3,5-triazine-2,4,6-triyl) tris(([1,1-biphenyl]-4-formaldehyde)); and 2,4,6-tris(4-formyl-biphenyl-4-yl)-1,3,5-triazine; and
the second organic monomer includes one of p-phenylenediamine; 2,5-diaminopyridine; benzidine; 4,4-diaminoterphenyl; hydrazine hydrate; terephthalicdihydrazide; 2,5-diethoxybenzene-1,4-bis(formylhydrazine); 2,5-bis(allyloxy)p-phenylhydrazide; 1,3,5-tris(4-aminophenyl)benzene; 2,4,6-tris(4-aminophenyl)-1,3,5-triazine; tris(4-aminophenyl amine); 5″-(4-amino [1,1-biphenylyl]-4-yl)[1,1′:4,1″:3″,1′″:4′″,1″″-quinquephenyl]-4,4″-diamine; 4,4″,4′″″-(1,3,5-triazine-2,4,6-triyl) tris(([1,1-biphenyl]-4-amine)); 2,7,12-triamino-5H-diindolyl[1,2-a: 1;2′-c]fluorene-5,10,15-trione, 2,4,6-tris(3-hydroxyl-4-amino phenyl)-1,3,5-triazine; benzene-1,3,5-tricarbohydrazide; N,N,N′,N′-tetra(p-amino phenyl)p-phenylenediamine; and tetra-(4-amino phenyl) vinyl.

23. The method in claim 22, further comprising of the steps of:
preparing the first organic monomer which includes 3-connector building blocks; and
preparing the second organic monomer which includes 4-connector building blocks.

24. The method in claim 22, further comprising of the steps of:
preparing the first organic monomer which includes 2-connector building blocks; and
preparing the second organic monomer which includes 3-connector building blocks.

25. The method in claim 11, wherein the covalent organic framework material forms one of blocks, cylinders and foams.

26. The method in claim 11, wherein the covalent organic framework material has pores whose diameter ranges from 0.6-4.9 nm.

27. The method in claim 11, wherein:
a molar ratio of the first organic monomer to the second organic monomer ranges from 1:4 to 4:1; and
a molar ratio of the catalyst to the first organic monomer ranges from 1:5 to 5:1.

28. The method in claim 11, further comprising the step of:
preparing the first organic monomer and the second organic monomer in a condensation reaction for 3-7 days under 0-1 atm at 20-250° C.

29. The method in claim 11, further comprising the step of:
starting the condensation reaction under a negative pressure.
